(19) United States
(12) Patent Application Publication
(10) Pub. No.: US 2013/0173208 A1
(43) Pub. Date: Jul. 4, 2013

(54) ROAD SURFACE INSPECTION DEVICE AND RECORDING MEDIUM

(71) Applicant: FUJITSU LIMITED, Kawasaki-shi (JP)

(72) Inventors: Kazuyoshi KUZUNISHI, Hasuda (JP); Takashi SHIMADA, Shinagawa (JP); Fumiaki SUZUKI, Komae (JP); Hiroyuki TANI, Katsushika (JP); Kosei TAKANO, Fujimino (JP); Masahiro KAWASAKI, Kawasaki (JP)

(73) Assignee: FUJITSU LIMITED, Kawasaki-shi (JP)

(21) Appl. No.: 13/671,635

(22) Filed: Nov. 8, 2012

(30) Foreign Application Priority Data
Dec. 28, 2011 (JP) 2011-290027

(51) Int. Cl. G01B 5/28; G06F 19/00

(52) U.S. Cl. CPC G01B 5/28; G06F 19/00; G01C 1/00
USPC 702/141; 73/104

(57) ABSTRACT

The road surface inspection process includes acquiring, calculating, and determining. The acquiring includes acquiring a deterioration candidate position at which a deterioration candidate of a road surface is detected by a process of detecting an abnormality on the road surface of a road. The calculating includes calculating a frequency at which an acceleration outside an allowable range is measured at the deterioration candidate position by referring to an acceleration at a measurement position corresponding to the deterioration candidate position among the accelerations stored in a driving data storage. The determining includes determining, when the calculated frequency is equal to or greater than a predetermined threshold value, that the deterioration candidate position at which the frequency is calculated is a position at which the road surface is deteriorated.

### CROSS-REFERENCE TO RELATED APPLICATION

This application is based upon and claims the benefit of priority of the prior Japanese Patent Application No. 2011-290027, filed on Dec. 28, 2011, the entire contents of which are incorporated herein by reference.

### FIELD

The embodiments discussed herein are related to a road surface inspection device.

### BACKGROUND

The surface of a road is deteriorated by a vehicle traffic load and the action of a natural environment. It is preferable to detect the road surface deterioration at an early stage from the perspective of driving safety and maintenance cost. As an example of a technique of detecting a road surface state, a road information and communication system is proposed. In the road information and communication system, vibrating position information in which road surface vibration information and GPS measurement information are correlated is collected from a plurality of vehicles on which an on-vehicle navigation device is mounted, and the vibrating position information is distributed to the respective vehicles.

Patent Literature 1: Japanese Laid-open Patent Publication No. 2001-004382

However, in the related art, there is a problem in that there is a limit in the detection accuracy of road surface deterioration as will be described below.

That is, the road information and communication system merely detects vibration of a road surface based on a change in acceleration in order to ensure safe driving of vehicles by warning drivers of vibrating positions and informing drivers to avoid the vibrating positions. That is, even when vibration of the road surface is detected, it cannot be said that the cause of the vibration lies in the road surface deterioration, and vibration is detected even when a waste or a small stone is present on the road. As above, in the road information and communication system, since a position where a waste, a small stone, or the like is present on the road is collected as the vibrating position information, the detection accuracy of the road surface deterioration decreases.

### SUMMARY

According to an aspect of the embodiments, a road surface inspection device includes a memory and a processor coupled to the memory. The processor executes a process including: acquiring a deterioration candidate position at which a deterioration candidate of the road surface is detected by a process of detecting an abnormality on the road surface of a road; calculating a frequency at which an acceleration outside an allowable range is measured at the deterioration candidate position by referring to an acceleration at a measurement position corresponding to the deterioration candidate position acquired by the acquiring among the accelerations stored in a driving data storage in which the acceleration measured in a direction parallel to the road surface on which a vehicle drives by an acceleration sensor mounted on the vehicle and the measurement position at which the acceleration is measured are stored in correlation; and determining, when the frequency calculated by the calculating is equal to or greater than a predetermined threshold value, that the deterioration candidate position at which the frequency is calculated is a position at which the road surface is deteriorated.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of a road surface inspection system according to a first embodiment;

FIG. 2 is a block diagram illustrating a functional configuration of a simplified device according to the first embodiment;

FIG. 3 is a block diagram illustrating a functional configuration of a road surface inspection device according to the first embodiment;

FIG. 4 is a diagram illustrating an example of wheel trace data;

FIG. 5 is a diagram illustrating an example of a tag used for description of deterioration candidate data;

FIG. 6 is a diagram illustrating a configuration example of deterioration candidate data;

FIG. 7 is a diagram illustrating an example of business vehicle data;

FIG. 8 is a diagram illustrating an example of digitacho data;

FIG. 9 is a diagram illustrating an example of a road image;

FIG. 10 is a diagram illustrating an example of a road image;

FIG. 11 is a diagram illustrating an example of a road image;

FIG. 12 is a diagram illustrating an example of a screen transmitted to a subscriber terminal;

FIG. 13 is a diagram illustrating an example of a screen transmitted to a subscriber terminal;

FIG. 14 is a flowchart illustrating the flow of a process of detecting a deterioration candidate position according to the first embodiment;

FIG. 15 is a flowchart illustrating the flow of a process of detecting a deterioration position according to the first embodiment;

FIG. 16 is a sequence diagram illustrating a service providing process between the road surface inspection device and the subscriber terminal according to the first embodiment;

FIG. 17 is a diagram illustrating a modification example of wheel trace data; and

FIG. 18 is a diagram for explaining an example of a computer that executes the road surface inspection program according to first and second embodiments.

### DESCRIPTION OF EMBODIMENTS

Preferred embodiments will be explained with reference to accompanying drawings. These embodiments do not limit the technique disclosed herein. The respective embodiments can be appropriately combined with each other within a range where the processing contents are not contradictory to each other.

### [a] First Embodiment

System Configuration

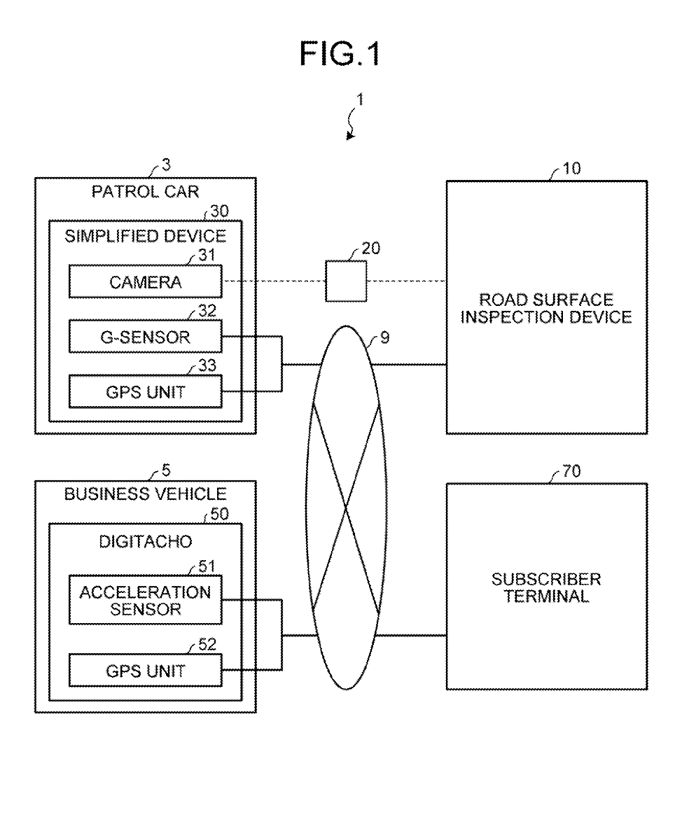

First, a configuration of a road surface inspection system according to this embodiment will be described. FIG. 1 is a diagram illustrating the configuration of a road surface inspection system according to the first embodiment. A road surface inspection system 1 illustrated in FIG. 1 determines whether a deterioration candidate position that is detected by a road surface irregularity detection process as a candidate position at which a road surface is deteriorated is a deterioration position by determining whether the deterioration candidate position is a position at which a business vehicle 5 frequently decelerates or turns.

As illustrated in FIG. 1, the road surface inspection system 1 includes a road surface inspection device 10, a simplified device 30, a digital tachograph 50, and a subscriber terminal 70. In the example of FIG. 1, although a case where the road surface inspection system 1 includes one simplified device 30, one digital tachograph (in the drawing, referred to as a digitacho), and one subscriber terminal 70 is illustrated, the disclosed system is not limited to this. That is, the disclosed system can be applied to a case where any number of simplified devices, digital tachographs, and subscriber terminals are included.

The road surface inspection device 10, the simplified device 30, the digital tachograph 50, and the subscriber terminal 70 are connected to one another so that they can communicate with one another via a network 9. As the network 9, an optional communication network such as the Internet, a local area network (LAN), or a virtual private network (VPN) can be employed regardless of whether the network 9 is a wired network or a wireless network. The road surface inspection device 10 and the simplified device 30 may exchange data via a memory card 20 as well as the network 9.

The simplified device 30 is an on-vehicle machine that is mounted on a patrol car 3. The patrol car 3 on which the simplified device 30 is mounted is a vehicle used for patrolling the road, and an automobile of an optional type can be employed as the patrol car 3 regardless of the size of a vehicle such as a light automobile, an ordinary automobile, or a large automobile, the purpose of use of a vehicle such as an ordinary vehicle, a business vehicle, or a special-purpose vehicle, and the number of wheels of a vehicle such as a four-wheel vehicle or a two-wheel vehicle.

A minimum number of sensors for allowing the road surface inspection device 10 described below to detect deterioration candidates of a road surface are mounted on the simplified device 30. For example, the simplified device 30 includes a camera 31, a gravitation (G) sensor 32, and a global positioning system (GPS) unit 33. Although the example of FIG. 1 illustrates a case where three sensors are mounted on the simplified device 30, the device disclosed herein is not limited to this. That is, when at least the camera 31 and the G-sensor 32 are mounted on the simplified device 30, the simplified device 30 can allow the road surface inspection device 10 to detect deterioration candidates of the road surface. A vehicle speed sensor, a gyro sensor, and the like can be also mounted in addition to the above sensors.

Among these sensors, the camera 31 is attached at a position where the camera 31 can image the road surface of a road. For example, the camera 31 may be attached to a predetermined position (for example, around the front number plate) of the front of the patrol car 3, or may be attached to a predetermined position (for example, around the rear number plate) of the rear of the patrol car 3. Moreover, the G-sensor 32 and the GPS unit 33 may be attached to an optional position of the patrol car 3. In this case, when the G-sensor 32 is provided at a position where shaking of the vehicle body is not absorbed by a suspension of the patrol car 3, minute shaking due to a small stone or an inclination of a slope other than a road surface deterioration such as a bump, a groove, or a crack results in an increase in the measured acceleration in the gravitational direction. Thus, the G-sensor 32 is preferably provided at a position where shaking of the vehicle body is absorbed by a suspension of the patrol car 3. In the following description, the image of the road captured by the camera 31 is sometimes referred to as a “road image.” Moreover, in the following description, acceleration data including the acceleration in the gravitational direction measured by the G-sensor 32 and position data including the coordinate values of the longitude and latitude measured by the GPS unit 33 are sometimes collectively referred to as “sensing data.”

The simplified device 30 uploads the road image and the sensing data to the road surface inspection device 10. As an embodiment, the simplified device 30 uploads the sensing data via the network 9 and uploads the road image via the memory card 20. As above, when uploading is performed via the memory card 20, the simplified device 30 writes video data of a movie including frames of a plurality of road images into the memory card 20. The memory card 20 is carried to the road surface inspection device 10 or the subscriber terminal 70 by an inspector being aboard the patrol car 3, and the video data is read after the memory card 20 is inserted to a card reader mounted on the road surface inspection device 10 or the subscriber terminal 70. In this case, when the video data is read by the subscriber terminal 70, the video data is uploaded from the subscriber terminal 70 to the road surface inspection device 10 via the network 9. As the memory card 20, a semiconductor memory capable of rewriting data such as a flash memory or a nonvolatile static random access memory (NVSRAM) can be employed. Moreover, a storage device such as a hard disk or an optical disc can be used instead of the memory card 20.

As above, when the simplified device 30 is mounted on the patrol car 3, it is not necessary to provide a number of radar-based displacement meters or a number of cameras such as a road surface state measurement vehicle, and it is not necessary to provide a measurement control device for performing adaptive measurement with a radar displacement meter or a camera.

In this example, although a case where the road image is uploaded via the memory card 20 has been illustrated, the road image may be uploaded via the network 9 similarly to the sensing data. Moreover, when the video data or the sensing data is uploaded via the network 9, the data may be uploaded in realtime and may be uploaded in a batch process.

The digital tachograph 50 is a device that electronically records a driving history of a vehicle. In the following description, the digital tachograph 50 is sometimes referred to as a “digitacho 50.” Although a number of business vehicles 5 such as a truck or a taxi are illustrated as an example of a vehicle on which the digitacho 50 is mounted, the disclosed device is not limited to this, and the digitacho 50 can be mounted on and employed in an optional vehicle.

The digitacho 50 includes at least an acceleration sensor 51 and a GPS unit 52. As an embodiment, as the acceleration sensor 51, an acceleration sensor capable of measuring an acceleration at least in a direction parallel to the road surface on which the business vehicle 5 drives, that is, at least two-axial directions including a longitudinal direction and a horizontal direction of the business vehicle 5 is employed. In the following description, a case where the acceleration sensor 51 capable of measuring an acceleration in three axes of the X-axis which is the longitudinal direction, the Y-axis which is the horizontal direction, and the Z-axis which is the vertical direction (the gravitational direction) of the business vehicle 5 is mounted on the digitacho 50 will be considered.

In such a configuration, when an acceleration is measured by the acceleration sensor 51, the digitacho 50 determines whether an acceleration in each of the X-axis direction which is the longitudinal direction and the Y-axis direction which is the horizontal direction of the business vehicle 5 is equal to or greater than a predetermined threshold value. That is, the digitacho 50 determines whether the business vehicle 5 decelerates with predetermined momentum or greater by making threshold determination on the acceleration in the X-axis direction, and determines whether the business vehicle 5 turns by making threshold determination on the acceleration in the Y-axis direction. Moreover, the digitacho 50 uploads digitacho data to the road surface inspection device 10 in which an acceleration in the X-axis direction of a predetermined value or more and/or an acceleration in the Y-axis direction of a predetermined value or more, and the coordinate values of the latitude and longitude measured by the GPS unit 52 at the measurement time of the acceleration are correlated.

In this example, although a case where only the digitacho data in which an acceleration of a predetermined value or more is measured is uploaded is described, the disclosed device is not limited to this. That is, the digitacho 50 may upload all digitacho data in which the values of three-axial accelerations, the coordinate values of the latitude and longitude, and the measurement time are correlated with each measurement cycle of the acceleration sensor 51 and the GPS unit 52.

The road surface inspection device 10 is a server device that provides a road surface inspection service. The road surface inspection device 10 may be implemented as a web server and may be implemented as a cloud server. As an embodiment, the road surface inspection device 10 detects a deterioration candidate position at which a road image or an acceleration in the gravitational direction satisfies a predetermined condition as a deterioration candidate position using the video data or the sensing data uploaded from the simplified device 30. Further, the road surface inspection device 10 extracts a position corresponding to the deterioration positions at which deceleration or turning of a predetermined amount or more occurs frequently among the deterioration candidate positions detected as the candidate positions where the road surface is deteriorated using the digitacho data uploaded from the digitacho 50. In addition, upon receiving a deterioration position browse request from the subscriber terminal 70 described below, the road surface inspection device 10 provides the following information to the subscriber terminal 70. That is, the road surface inspection device 10 provides the road image in which a road surface deterioration is detected and information such as an acceleration in the gravitational direction, the occurrence frequency of deceleration or turning of a predetermined amount or more, and the coordinate values of the latitude and longitude to the subscriber terminal 70.

The subscriber terminal 70 is a terminal device which is used by a subscriber who subscribes to the road surface inspection service. As an embodiment of the subscriber terminal 70, a fixed terminal including a personal computer (PC) can be employed. As another embodiment, a mobile terminal such as a portable phone, a personal handyphone system (PHS), or a personal digital assistant (PDA) can also be employed.

Here, the road surface inspection device 10 according to this embodiment determines whether a deterioration candidate position is a deterioration position by determining whether the deterioration candidate position detected as the candidate position at which the road surface is deteriorated is a position at which deceleration or turning of a predetermined amount or more occurs frequently. Thus, in the road surface inspection device 10 according to this embodiment, rather than relying on detection of one state which involves determining whether discoloration or irregularity is present on the road surface, it is possible to verify the detection result from various perspectives including the perspective of the cause of road surface deterioration by determining whether the deterioration candidate position is a position at which deceleration or turning of a predetermined amount or more which serves as the cause of the road surface deterioration occurs frequently. Therefore, in the road surface inspection device 10 according to this embodiment, it is possible to detect the deterioration position by narrowing down to a position at which the cause of road surface deterioration occurs frequently. Thus, according to the road surface inspection device 10 according to this embodiment, it is possible to improve the detection accuracy of road surface deterioration.

Configuration of Simplified Device 30

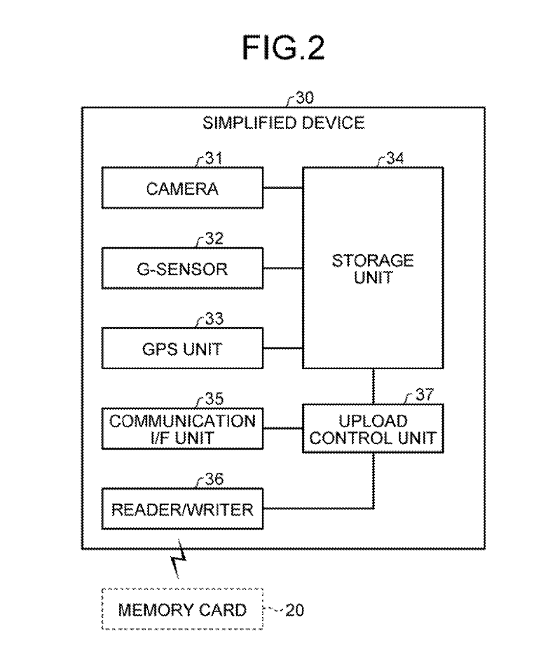

Next, a functional configuration of the simplified device 30 included in the road surface inspection system according to this embodiment will be described. FIG. 2 is a block diagram illustrating a functional configuration of the simplified device 30 according to the first embodiment. As illustrated in FIG. 2, the simplified device 30 includes the camera 31, the G-sensor 32, the GPS unit 33, a storage unit 34, a communication interface (I/F) unit 35, a reader/writer 36, and an upload control unit 37. The simplified device 30 may further include another sensor such as, for example, a vehicle speed sensor, a gyro sensor, or a steering angle sensor, other than the above sensors.

Among these sensors, the camera 31 is an imaging device that captures an image using an imaging element such as a charge coupled device (CCD) or a complementary metal oxide semiconductor (CMOS). As an embodiment, when capturing a road image at a predetermined frame rate, the camera 31 correlates the road image with a captured time by embedding the captured time in the frames of the road image as header information and then stores the road image in the storage unit 34. The captured time may be an elapsed time from the first frame of the road image, and may use a global time measured according to a time stamp or the like. Moreover, the frame rate may be set to a value such that the same position of a road partially overlaps between the frames of the road image. For example, 24 frames per second (fps), 30 fps, 60 fps, and the like can be employed. In the following description, it is assumed that video data in which the road image is encoded in encoding data of a movie by an encoder (not illustrated) is stored in the storage unit 34 described below.

The G-sensor 32 is a sensor that measures an acceleration in the gravitational direction. As an embodiment, when measuring an acceleration in the gravitational direction, the G-sensor 32 stores the acceleration data in which the acceleration and the measured time are correlated in the storage unit 34 described below. As a method of measuring the acceleration, an optional method such as a mechanical method or a chemical method including a semiconductor method can be employed. In the following description, although a case where the G-sensor 32 measures the acceleration in the gravitational direction at a cycle of one second is considered, the measurement cycle of the G-sensor 32 is not limited to this, and the G-sensor 32 can be applied to a case where the acceleration in the gravitational direction is measured at an optional cycle. Moreover, although this example illustrates a case where the simplified device 30 includes the G-sensor 32 that measures the acceleration in the gravitational direction, a three-axis acceleration sensor that measures accelerations in the X, Y, and Z-axis directions can also be employed.

The GPS unit 33 is a unit that measures the coordinate values of the latitude and longitude by receiving radio waves from a plurality of GPS satellites and calculating the distance to the respective GPS satellites. As an embodiment, when measuring the coordinate values of the latitude and longitude, the GPS unit 33 stores position data in the storage unit 34 described below so that the coordinate values and the measured time are correlated. In the following description, although a case where the GPS unit 33 measures the coordinate values of the latitude and longitude at a cycle of one second is considered, the measurement cycle of the GPS unit 33 is not limited to this, and the GPS unit 33 can be applied to a case where the coordinate values are measured at an optional cycle.

The storage unit 34 is a storage device that stores various types of data. As an embodiment of the storage unit 34, a storage device such as a hard disk or an optical disc can be employed in addition to a semiconductor memory capable of rewriting data such as a flash memory or a nonvolatile static random access memory (NVSRAM).

For example, the storage unit 34 stores sensing data such as acceleration data or position data including video data. In addition to this, the storage unit 34 stores wheel trace data that represents an expected trace on a road image, along which the wheels of the patrol car 3 pass on the road surface. The wheel trace data is set by calibrating the size and the position of a region on the road image, which the wheels are expected to pass using an attachment angle of the camera 31 attached to the patrol car 3.

The communication I/F unit 35 is an interface that controls the communication with other devices, for example, with the road surface inspection device 10. For example, the communication I/F unit 35 transmits the video data or the sensing data stored in the storage unit 34 to the road surface inspection device 10. As an embodiment of the communication I/F unit 35, a network interface card (NIC) such as a LAN card, or a modem can be employed.

In this example, although a case where the sensing data is transmitted to the road surface inspection device 10 via the communication I/F unit 35 is illustrated, it is not always necessary to execute the uploading via communication. For example, the sensing data may be uploaded via the memory card 20. In this case, the reader/writer 36 is controlled by the upload control unit 37 described below, whereby the sensing data is written to the memory card 20.

The reader/writer 36 is a device that reads data from the memory card 20 and writes data to the memory card 20. As an embodiment, the reader/writer 36 writes the wheel trace data to the memory card 20 together with the video data stored in the storage unit 34 upon receiving a write instruction from the upload control unit 37 described below in a state where the memory card 20 is attached to a predetermined position. In this example, although a case where the contact-type memory card 20 is employed is illustrated, a non-contact-type memory card may be employed as the memory card 20.

The upload control unit 37 is a processing unit that controls the uploading to the road surface inspection device 10. As an embodiment, when the sensing data such as the acceleration data and the position data is written to the storage unit 34 by the G-sensor 32 or the GPS unit 33, the upload control unit 37 controls the communication I/F unit 35 so as to transmit the sensing data to the road surface inspection device 10. Moreover, the upload control unit 37 performs the following process when an operation of writing video data is received from a road inspector, or the amount of the video data stored in the storage unit 34 reaches a predetermined data size. That is, the upload control unit 37 controls the reader/writer 36 so as to write the wheel trace data to the memory card 20 together with the video data stored in the storage unit 34. In this case, the upload control unit 37 may write the wheel trace data to the memory card 20 only when the attachment position of the camera 31 is changed so that the same wheel trace data is not uploaded redundantly. Moreover, the upload control unit 37 deletes uploaded sensing data and video data from the storage unit 34 when the sensing data is transmitted to the road surface inspection device 10 or when the video data is written to the memory card 20.

Various types of integrated circuits and electronic circuits can be employed as the upload control unit 37. An application specific integrated circuit (ASIC) is an example of the integrated circuit. Moreover, a central processing unit (CPU) and a microprocessing unit (MPU) are examples of the electronic circuit.

Configuration of Road Surface Inspection Device 10

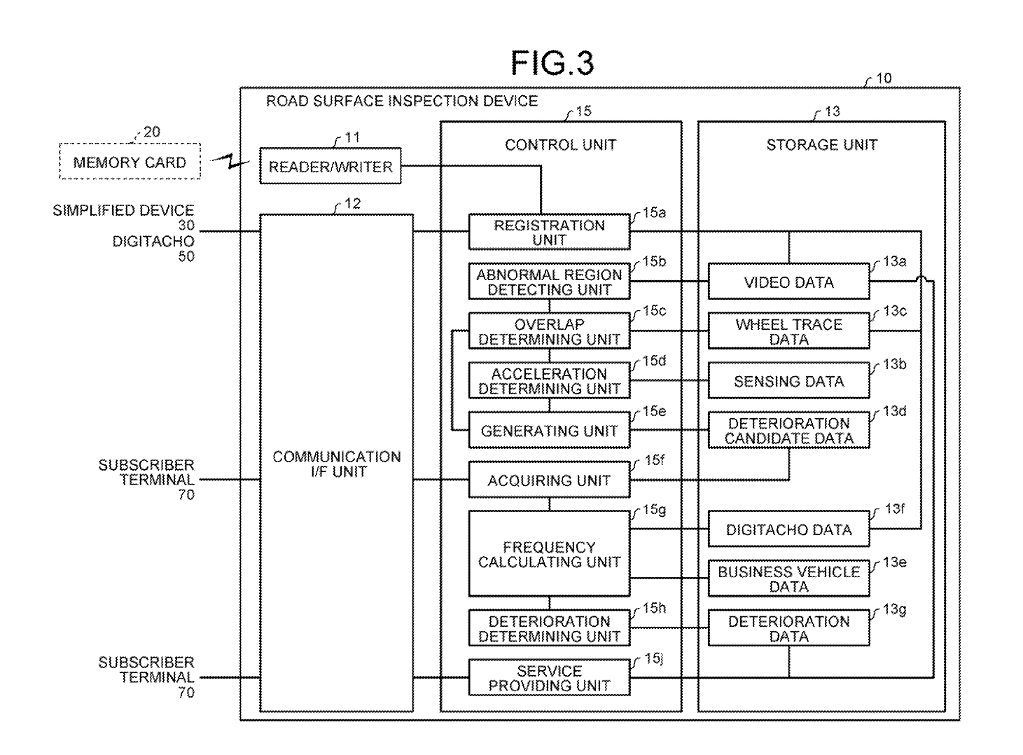

Next, a functional configuration of the road surface inspection device 10 according to this embodiment will be described. FIG. 3 is a block diagram illustrating a functional configuration of the road surface inspection device 10 according to the first embodiment. As illustrated in FIG. 3, the road surface inspection device 10 includes a reader/writer 11, a communication I/F unit 12, a storage unit 13, and a control unit 15. The road surface inspection device 10 includes various functional units included in the existing server device, for example, the functions of various input devices, various audio output devices, and the like, in addition to the functional units illustrated in FIG. 3.

Among these functional units, the reader/writer 11 is a device that reads data from the memory card 20 and writes data to the memory card 20. As an embodiment, the reader/writer 11 reads the wheel trace data together with the video data stored in the memory card 20 upon receiving a read instruction from a registration unit 15a described below in a state where the memory card 20 is attached to a predetermined position. Moreover, the reader/writer 11 outputs the video data and the wheel trace data to the registration unit 15a described below.

The communication I/F unit 12 is an interface that controls the communication with other devices, for example, with the simplified device 30, the digitacho 50, or the subscriber terminal 70. As an embodiment of the communication I/F unit 12, a network interface card such as a LAN card can be employed. For example, the communication I/F unit 12 receives the video data or the sensing data from the simplified device 30, receives the digitacho data from the digitacho 50, and transmits browsing data to be browsed by the road inspector to the subscriber terminal 70.

The storage unit 13 is a storage device such as a semiconductor memory device (for example, a flash memory), a hard disk, or an optical disc. The storage unit 13 is not limited to the above-mentioned storage device, but a random access memory (RAM) or a read only memory (ROM) may be used.

The storage unit 13 stores an operating system (OS) that is executed by the control unit 15 and various programs such as a road surface inspection program for inspecting the road surface. Further, the storage unit 13 stores video data 13a, sensing data 13b, wheel trace data 13c, and deterioration candidate data 13d as examples of data necessary for execution of the program executed by the control unit 15. In addition, the storage unit 13 stores business vehicle data 13e, digitacho data 13f, and deterioration data 13g.

The video data 13a is video data of the road imaged by the camera 31 mounted on the patrol car 3. As an example, in the video data 13a, video data read from the memory card 20 by the reader/writer 11 is registered by the registration unit 15a described below for each vehicle number of the patrol car 3 and for each route of the road. As another example, the video data 13a is referred to by an abnormal region detecting unit 15b described below in order to detect an abnormal region on the road image such as a region where discoloration is present in the pavement of the road surface. As a further example, the video data 13a is referred to by a service providing unit 15j described below so that the video data of the deterioration position is browsed.

The sensing data 13b is data including the acceleration data and the position data acquired by sensors that are mounted on the patrol car 3. As an example, in the sensing data 13b, sensing data received from the simplified device 30 is registered by the registration unit 15a described below for each vehicle number of the patrol car 3 and for each route. As another example, the sensing data 13b is referred to by an acceleration determining unit 15d described below in order to determine whether an abnormality such as irregularity is present in the acceleration in the gravitational direction.

The wheel trace data 13c is data that represents an expected trace on the road image, along which the wheels of the patrol car 3 pass on the road surface. As an example, in the wheel trace data 13c, wheel trace data received from the simplified device 30 is registered by the registration unit 15a described below for each vehicle number of the patrol car 3. As an other example, the wheel trace data 13c is referred to by an overlap determining unit 15c described below in order to determine whether an abnormal region on the road image in which discoloration or the like is detected in the pavement of the road surface overlaps the expected trace along which the wheels of the patrol car 3 pass on the road surface.

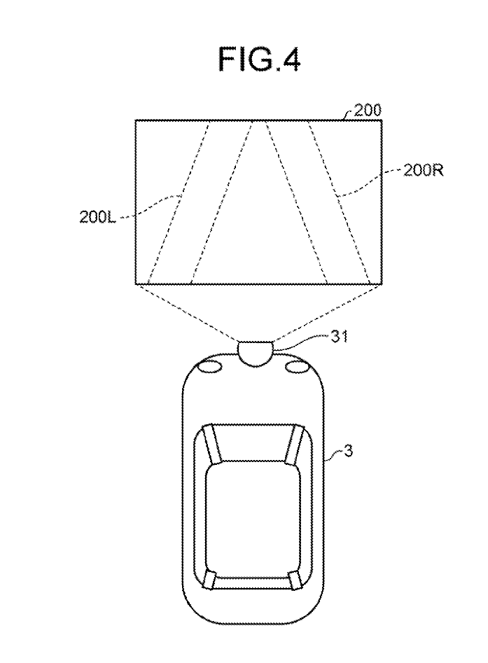

FIG. 4 is a diagram illustrating an example of the wheel trace data 13c. In the example of FIG. 4, a case where the camera 31 is attached to the front of the patrol car 3 will be considered. Reference numeral 200 illustrated in FIG. 4 represents a road image. Moreover, reference numerals 200L and 200R illustrated in FIG. 4 represent expected traces on the road image 200 along which the left and right wheels of the patrol car 3 pass on the road surface. The wheel trace data 13c is set by calibrating the size and the position of a region on the road image, which the left and right wheels are expected to pass using the attachment angle of the camera 31 attached to the patrol car 3.

As illustrated in FIG. 4, the two regions of the trace 200L on the road image 200, along which the left wheel of the patrol car 3 is expected to pass on the road surface, and the trace 200R on the road image 200, along which the right wheel of the patrol car 3 is expected to pass on the road surface are defined as the wheel trace data 13c. In the example of FIG. 4, although a case where the width in the horizontal direction of the traces 200L and 200R is fixed is illustrated, the traces 200L and 200R are preferably defined so that the width in the horizontal direction decreases as the trace approaches the disappearance point in the road image 200.

The deterioration candidate data 13d is various types of data regarding a deterioration candidate position. As an embodiment of the deterioration candidate data 13d, deterioration candidate data is generated by a generating unit 15e described below so that a change in the acceleration in the gravitational direction before and after capturing of the road image and the coordinate values of the latitude and longitude as well as the road image in which discoloration of the road surface or an abnormality in the acceleration is detected are correlated.

As an example, when an abnormality such as irregularity is detected in the acceleration in the gravitational direction at a timing at which the wheels of the patrol car 3 are expected to pass through an abnormal region on the road image in which discoloration is detected in the pavement of the road surface, deterioration candidate data of which the deterioration level is set to “high” is generated. As another example, even if discoloration is detected in the pavement of the road surface on the road image, when the abnormal region does not overlap the trace along which the wheels of the patrol car 3 are expected to pass, deterioration candidate data of which the deterioration level is set to “low” is generated. As a further example, even if discoloration is not detected in the pavement of the road surface on the road image, when an abnormality such as irregularity is detected in the acceleration in the gravitational direction, deterioration candidate data of which the deterioration level is set to “low” is generated. Here, the “deterioration level” represents an index that represents the degree of progress of the road surface deterioration, and is classified into, for example, two steps of “high” and “low.” In this example, although a case where the deterioration level is classified into two steps is illustrated, the deterioration level may be classified into three steps or more.

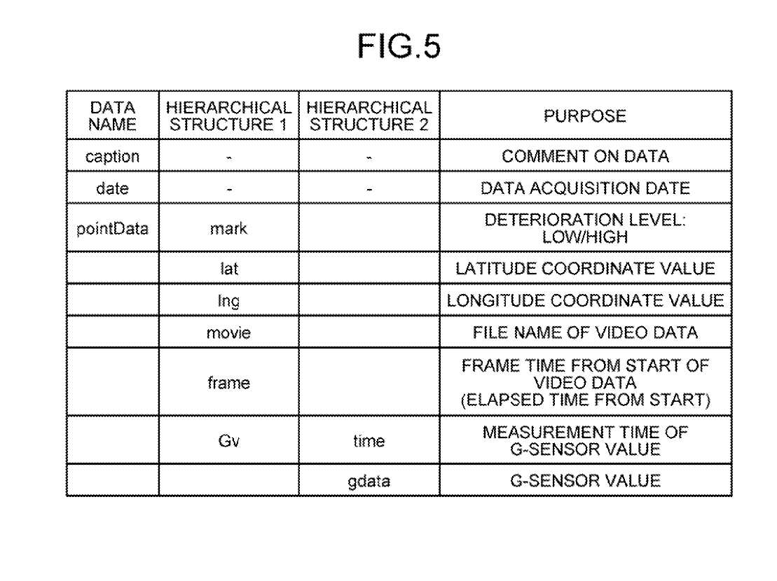

FIG. 5 is a diagram illustrating an example of a tag used for describing the deterioration candidate data 13d. As illustrated in FIG. 5, in description of the deterioration candidate data 13d, three tags of “caption,” “date,” and “pointData” are used. Among these tags, the tag “caption” is a tag used for describing a comment on data. The tag “date” is a tag used for describing the captured date of the video data. The tag “pointData” is a tag used for describing various items of information on the deterioration candidate position. Moreover, the “pointData” is further hierarchized to six low-level tags including “mark,” “lat,” “lng,” “movie,” “frame,” and “Gv.” Among these tags, the tag “mark” is a tag used for describing whether the deterioration level of the deterioration candidate data is “high” or “low.” The tag “lat” is a tag used for describing a coordinate value of latitude. The tag “lng” is a tag used for describing a coordinate value of longitude. The tag “movie” is a tag used for describing a file name of video data. The tag “frame” is a tag used for describing a captured time of a road image. The tag “Gv” is a tag used for describing various items of information on the G-sensor. Moreover, the tag “Gv” is further hierarchized into two low-level tags including “time” and “gdata.” Among these tags, the tag “time” is a tag used for describing a measurement time at which the G-sensor measures an acceleration in the gravitational direction. The tag “gdata” is a tag used for describing an acceleration in the gravitational direction measured by the G-sensor.

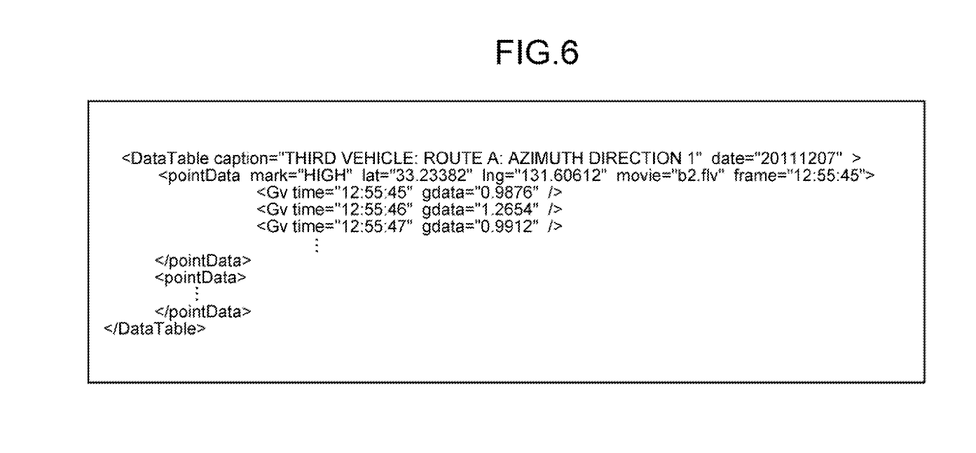

FIG. 6 is a diagram illustrating a configuration example of the deterioration candidate data 13d. In the example of FIG. 6, the deterioration candidate data 13d represents that the third patrol car 3 turns in an azimuth direction of “1” on a route A on 2011/12/07 (yyyy/mm/dd). Here, the “azimuth direction” represents a code allocated to each of the 16 azimuth directions of north (N), south (S), east (E), and west (W), which are divided clockwise starting from the north direction. That is, a code “1” is allocated to the north, a code “2” is allocated to the north-northeast (NNE), and a code “3” is allocated to the northeast (NE). In this way, a code “16” is allocated to the north-northwest (NNW). Thus, the example of FIG. 6 illustrates that the third patrol car 3 turns in the “north” direction on the route A.

Further, the “pointData” on the first row illustrated in FIG. 6 represents that the deterioration candidate data is deterioration candidate data of which the deterioration level is “high” and in which an abnormality such as irregularity is detected in the acceleration in the gravitational direction at a timing at which the wheels of the patrol car 3 are expected to pass through an abnormal region where a discoloration is detected in the pavement of the road surface on the road image. In addition, the “pointData” on the first row illustrated in FIG. 6 represents that the road image in which a road surface deterioration is detected is captured at a position at which the latitude is “33:23:382 (hh:mm:sss),” and the longitude is “131:60:612.” Furthermore, the “pointData” on the first row illustrated in FIG. 6 represents that the file name of the video data including the road image is “b2.flv.” Furthermore, the “pointData” on the first row illustrated in FIG. 6 represents that the captured time of the road image in which candidates for the road surface deterioration are detected is “12:55:45.” Furthermore, the “pointData” on the first row illustrated in FIG. 6 represents that the following acceleration in the gravitational direction is measured for three minutes “12:55:45 (hh:mm:ss) to 12:58:45” around the timing at which the wheels of the patrol car 3 are expected to pass through an abnormal region where a discoloration is detected in the pavement of the road surface on the road image. That is, the “pointData” represents that the acceleration in the gravitational direction is changing from 0.9876 cm/s² to 1.2654 cm/s², 0.9912 cm/s², and so on every second from the time 12:55:45. The example of FIG. 6 illustrates a case where the camera 31 is attached to the front of the patrol car 3, and a change in the acceleration in the gravitational direction for three minutes from the captured time of the road image is correlated with the road image in which the road surface deterioration is detected.

The business vehicle data 13e represents various types of data regarding the business vehicle 5. As an example, the business vehicle data 13e is referred to by a frequency calculating unit 15g to be described below in order to specify the type of the business vehicle 5 that passes through the deterioration candidate position.

As for the business vehicle data 13e, various types of data regarding vehicle inspection registered in advance by a subscriber who subscribes to a digitacho data browsing service can be used. As an embodiment, data in which a registration number and a vehicle class of the business vehicle 5 are correlated can be employed as the business vehicle data 13e. The “registration number” mentioned herein represents a number that is registered in order to identify the business vehicle 5 when the business vehicle 5 subscribes to the digitacho data browsing service. Moreover, the “vehicle class” represents a classification of vehicles, and examples of the vehicle class include a very large size, a large size, a mid-size, an ordinary size, and a compact size. The vehicle classification is not limited to the size-based class of a vehicle body, and from the perspective of strictly classifying the loading capacity, the purpose-based classes such as a taxi, a bus, or a truck may be further correlated.

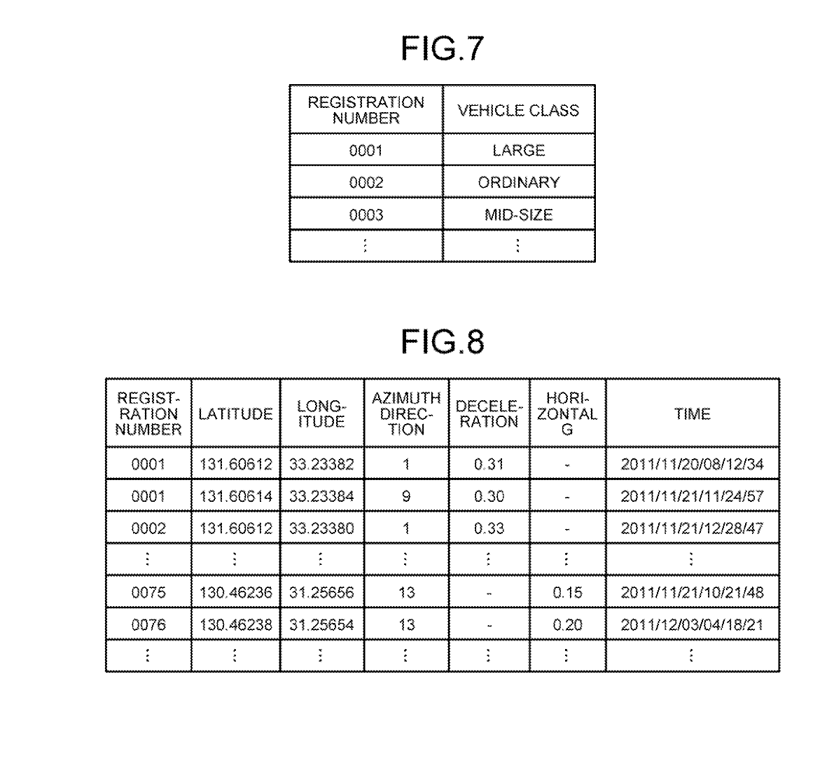

FIG. 7 is a diagram illustrating an example of the business vehicle data 13e. In the example of FIG. 7, the business vehicle 5 having a registration number of “0001” is a large-size car, the business vehicle 5 having a registration number of “0002” is an ordinary-size car, and the business vehicle 5 having a registration number of “0003” is a mid-size car. Although the example of FIG. 7 illustrates the business vehicle data in which the registration number and the vehicle class are correlated, an optional items which can be the cause of the road surface deterioration such as the weight of a vehicle, a loading capacity, or a wheel arrangement pattern may be further correlated.

The digitacho data 13f represents various types of data regarding a digital tachograph. As an example, in the digitacho data 13f, digitacho data received from the digitacho 50 is registered for each registration number and each route of the business vehicle by the registration unit 15a to be described below. As another example, the digitacho data 13f is referred to by the frequency calculating unit 15g to be described below in order to calculate the occurrence frequency of abrupt deceleration and hard turn at the deterioration candidate position.

As an embodiment, as the digitacho data 13f, data in which the registration number, the longitude, the latitude, the azimuth direction, the deceleration, the horizontal G, and the measurement date are correlated can be employed. The “deceleration” mentioned herein represents the amount of decrease in the speed of a vehicle per unit time, and for example, an acceleration in the backward direction of the vehicle or an acceleration in the backward direction of the vehicle is expressed in terms of the gravitational acceleration. Moreover, the “horizontal G” is an index that expresses an acceleration in the horizontal direction of the vehicle, that is, the Y-axis direction, in terms of the gravitational acceleration.

FIG. 8 is a diagram illustrating an example of the digitacho data 13f. The first record illustrated in FIG. 8 represents that a deceleration of “0.31” is measured when the business vehicle 5 having a registration number of “0001” drives in the north direction at the time “2011/11/20, 08/12/34 (yyyy/mm/dd, hh/mm/ss)” while passing through a position at which the longitude is “131:60:612” and the latitude is “33:23:382.” Further, the second record illustrated in FIG. 8 represents that a deceleration of “0.30” is measured when the business vehicle 5 having a registration number of “0001” drives in the south direction at the time “2011/11/21, 11/24/57” while passing through a position at which the longitude is “131:60:614” and the latitude is “33:23:384.” In addition, the third record illustrated in FIG. 8 represents that a deceleration of “0.33” is measured when the business vehicle 5 having a registration number of “0002” drives in the north direction at the time “2011/11/21, 12/28/47” while passing through a position at which the longitude is “131:60:612” and the latitude is “33:23:380.”

Moreover, the fourth record illustrated in FIG. 8 represents that a horizontal G of “0.15” is measured when the business vehicle 5 having a registration number of “0075” drives in the west direction at the time “2011/11/21, 10/21/48” while passing through a position at which the longitude is “130:46:236” and the latitude is “31:25:656.” Further, the fifth record illustrated in FIG. 8 represents that a horizontal G of “0.20” is measured when the business vehicle 5 having a registration number of “0076” drives in the west direction at the time “2011/12/03, 04/18/21” while passing through a position at which the longitude is “130:46:238” and the latitude is “31:25:654.”

In the example of FIG. 8, it is determined that the business vehicle 5 makes an abrupt deceleration when a deceleration of 0.30 or more is measured by the digitacho 50, and it is determined that the business vehicle 5 makes a hard turn when a horizontal G of 0.15 or more is measured by the digitacho 50. Thus, in the example of FIG. 8, only the data in which a deceleration of 0.30 or more or a horizontal G of 0.15 or more is measured is registered. A deceleration of 0.30 or more is generally considered as deceleration caused by the use of a sudden braking. In this embodiment, although the above value is set as a threshold value that is regarded as an abrupt deceleration or a hard turn, the threshold value is not limited to the above value, and an optional value may be set to detect a deceleration or turn of a predetermined amount or more. For example, when a threshold value to be compared with a deceleration is set, by setting a threshold value for an expressway so as to be lower than that of an ordinary road, it is possible to collect a larger number of abrupt deceleration samples from the high-speed region. Moreover, when a threshold value to be compared with the horizontal G is set, by setting a threshold value for a high-speed corner so as to be lower than that of a low-speed corner, it is possible to collect a larger number of hard turn samples from the high-speed region.

The deterioration data 13g represents various types of data regarding a deterioration position. As an example, deterioration candidate data in which the deterioration candidate position is a position at which an abrupt deceleration or a hard turn occurs frequently among the deterioration candidate data is registered as the deterioration data 13g. As for the deterioration data 13g, the items of the deterioration candidate data 13d excluding the abrupt deceleration occurrence frequency or the hard turn occurrence frequency are used. For example, data in which a change in the acceleration in the gravitational direction around the captured time of the road image, the coordinate values of the latitude and longitude, and the occurrence frequencies of an abrupt deceleration and a hard turn including the road image of the deterioration position are correlated is registered by a deterioration determining unit 15h to be described below as the deterioration data 13g. As an example, in description of the abrupt deceleration occurrence frequency, a tag “Df” can be embedded under the tag “pointData.” Moreover, as an example, in description of the hard turn occurrence frequency, a tag “Sf” can be embedded under the tag “pointData.”

The control unit 15 includes an internal memory for storing control data and a program in which various processing procedures are described, and executes various processes using the program and the control data. As illustrated in FIG. 3, the control unit 15 includes the registration unit 15a, the abnormal region detecting unit 15b, the overlap determining unit 15c, the acceleration determining unit 15d, the generating unit 15e, an acquiring unit 15f, the frequency calculating unit 15g, the deterioration determining unit 15h, and the service providing unit 15j.

Among these units, the registration unit 15a is a processing unit that registers various types of data uploaded from the simplified device 30 and the digitacho 50 in the storage unit 13. As an embodiment, the registration unit 15a registers sensing data in the storage unit 13 for each vehicle number of the patrol car 3 upon receiving the sensing data from the simplified device 30. In this case, the registration unit 15a divides the sensing data into respective routes using map data (not illustrated), for example, node link data in which nodes that represent intersections and links that represent routes such as a national road, a prefectural road, or a city street, and registers the divided sensing data in the storage unit 13 for each route.

As another embodiment, the registration unit 15a registers video data in the storage unit 13 for each vehicle number of the patrol car 3 when the video data is read from the memory card 20 by the reader/writer 11. In this case, the registration unit 15a divides the video data into respective routes using the node link data and position data of the sensing data 13b corresponding to the captured time of the video data and registers the divided video data in the storage unit 13 for each route. When the wheel trace data is read from the memory card 20 by the reader/writer 11, the wheel trace data is also registered in the storage unit 13 for each vehicle number of the patrol car 3 in conformity with the registration of the video data.

As a further embodiment, the registration unit 15a registers digitacho data in the storage unit 13 for each registration number of the business vehicle 5 upon receiving the digitacho data from the digitacho 50. In this case, the registration unit 15a divides the digitacho data using the node link data into respective routes and registers the divided digitacho data in the storage unit 13 for each route.

The abnormal region detecting unit 15b is a processing unit that detects an abnormal region of the road surface pavement from the road surface on the road image using the video data 13a.

As an embodiment, the abnormal region detecting unit 15b starts its processing when new video data 13a is registered in the storage unit 13. First, the abnormal region detecting unit 15b sequentially reads the frames of a road image included in the video data 13a stored in the storage unit 13. Moreover, the abnormal region detecting unit 15b specifies a target region that is to be subjected to image processing within the road image. For example, the abnormal region detecting unit 15b calculates a predetermined fraction (for example, half height H2) of the height H1 of a vanishing point Vp that is obtained in advance by calibration from the angle of view of the camera 31 within the road image. Moreover, the abnormal region detecting unit 15b narrows the road image down to a region E having the calculated height H2 or smaller and then executes the subsequent image processing. The reason why the target region to be subjected to image processing is restricted is to exclude a region which is near the vanishing point on the road image and in which only a small amount of details are captured from the target region to be subjected to image processing and to reduce the amount of computation associated with image processing. In the following description, the region having the height of H2 or smaller within the road image is sometimes referred to as an “image processing execution target region.”

After that, the abnormal region detecting unit 15b detects an abnormal region, in which it can be estimated that a discoloration or the like is present in the pavement of the road surface, from the specified image processing execution target region E. For example, the abnormal region detecting unit 15b calculates an average value of intensity or hue of the respective pixels in the image processing execution target region E. Moreover, the abnormal region detecting unit 15b extracts pixels of which the color difference from the average value of the intensity or hue of the respective pixels is equal to or greater than a predetermined threshold value Δa and labels a region in which the pixels having a color difference of the threshold value Δa or more are continuous. By the labeling, the abnormal region detecting unit 15b detects an abnormal region in which it can be estimated that a discoloration is detected from the colors of the asphalt or the cement.

The overlap determining unit 15c is a processing unit that determines whether the abnormal region detected by the abnormal region detecting unit 15b overlaps the trace along which the wheels of the patrol car 3 are expected to pass on the road surface using the wheel trace data 13c.

As an embodiment, the overlap determining unit 15c calculates the number of pixels that constitute the abnormal region, that is, the area of the abnormal region, and then determines whether the area of the abnormal region is equal to or greater than a predetermined threshold value Δb. In this case, the overlap determining unit 15c may calculate the area of the abnormal region by setting a greater weight to pixels that are near the vanishing point among the pixels that constitute the abnormal region. By determining the size of the area, the overlap determining unit 15c determines whether the abnormal region has a size such that it can be estimated that the abnormal region is a bump, a groove, or a crack on the road surface, that is, whether the abnormal region is a small stone or the like.

When the area of the abnormal region is smaller than the predetermined threshold value Δb, it can be estimated that the abnormal region is less likely to be a bump, a groove, or a crack on the road surface. Thus, the overlap determining unit 15c does not execute the subsequent image processing. On the other hand, when the area of the abnormal region is equal to or greater than the predetermined threshold value Δb, it can be estimated that the abnormal region is highly likely to be a bump, a groove, or a crack on the road surface. Thus, the overlap determining unit 15c further determines whether an average value of the luminance of the pixels that constitute the abnormal region is equal to or smaller than a predetermined threshold value Δc. By determining the magnitude of the luminance, the overlap determining unit 15c can determine whether the abnormal region is such dark that it can be estimated that the abnormal region is different from a road mark such as a white line painted on the road surface.

Here, when the average value of the luminance of the pixels that constitute the abnormal region is equal to or smaller than the predetermined threshold value Δc, the overlap determining unit 15c further determines whether the abnormal region overlaps the trace along which the wheels of the patrol car 3 are expected to pass, defined by the wheel trace data 13c. By the overlap determination, it is possible to determine whether the wheels of the patrol car 3 pass on the abnormal region in the subsequent frames of the road image. In this case, when at least one of the pixels that constitute the abnormal region overlap the expected trace of the wheels, the overlap determining unit 15c determines that the abnormal region and the expected trace overlap.

In this embodiment, although a case where overlap determination between the abnormal region and the expected trace is executed in order to set a deterioration level is illustrated, since a position where either a discoloration or an irregularity is detected may be set as a deterioration candidate even when the abnormal region and the expected trace do not overlap, the overlap determination may be skipped.

The acceleration determining unit 15d is a processing unit that determines whether the acceleration at the measurement time corresponding to the captured time of the road image is outside a predetermined range R using the sensing data 13b. The fact that the acceleration is outside the predetermined range R means that a vehicle passes through a certain step.

As an embodiment, the acceleration determining unit 15d sets an acceleration monitoring target zone which starts from the captured time of the currently read road image and which includes a time at which it is expected that the wheels of the patrol car 3 pass through the abnormal region from the vehicle speed of the patrol car 3 that is obtained from an optical flow of the frames of the road image. For example, the acceleration determining unit 15d sets the captured time of the road image as the starting point of the monitoring target zone and sets the length to the ending point of the monitoring target zone so that the slower the vehicle speed of the patrol car 3, the greater the length. The vehicle speed of the patrol car 3 may be acquired from a vehicle speed sensor (not illustrated) mounted on the patrol car 3 without using the optical flow.

After that, the acceleration determining unit 15d determines whether any one of the maximum value and the minimum value of the acceleration in the gravitational direction corresponding to the monitoring target zone among the sensing data 13b is outside the predetermined range R. In this case, the acceleration determining unit 15d can also change the range R dynamically so that the slower the vehicle speed of the patrol car 3, the greater the difference between the upper limit value and the lower limit value of the range R. By the acceleration determination, the acceleration determining unit 15d can determine whether the abnormal region is an irregularity such as a bump, a groove, or a crack, that is, whether the abnormal region is a discoloration caused by a water pool having a small irregularity.

The generating unit 15e is a processing unit that generates deterioration candidate data. As an embodiment, when an abnormality such as irregularity is detected in the acceleration in the gravitational direction at a timing at which the wheels of the patrol car 3 are expected to pass through an abnormal region on the road image in which discoloration is detected in the pavement of the road surface, the generating unit 15e generates deterioration candidate data of which the deterioration level is set to “high.” That is, the generating unit 15e generates deterioration candidate data in which a change in the acceleration in the gravitational direction around the captured time of the road image in which an abnormality such as a discoloration is detected in the road surface pavement, and the coordinate values of the latitude and longitude, including the road image are correlated. In this case, the generating unit 15e describes the deterioration level as “high” in the tag “mark” of the tag “pointData.” Moreover, the generating unit 15e specifies the azimuth direction along which the vehicle drives from the locus of the coordinate values before the present road image is read and embeds the specified azimuth direction in the tag “caption.” Further, the generating unit 15e describes a change in the acceleration in the gravitational direction during a predetermined period (for example, 3 minutes) from the captured time of the road image in the tag “gdata” of the tag “Gv.”

As another embodiment, even if discoloration is detected in the pavement of the road surface on the road image, when the abnormal region does not overlap the trace along which the wheels of the patrol car 3 are expected to pass, the generating unit 15e generates deterioration candidate data of which the deterioration level is set to “low.” That is, the generating unit 15e generates deterioration candidate data in which a change in the acceleration in the gravitational direction around the captured time of the road image in which an abnormality such as a discoloration is detected in the road surface pavement, and the coordinate values of the latitude and longitude, including the road image are correlated. In this case, the generating unit 15e describes the deterioration level as “low” in the tag “mark” of the tag “pointData.” Moreover, the generating unit 15e specifies the azimuth direction along which the vehicle drives from the locus of the coordinate values before the present road image is read and embeds the specified azimuth direction in the tag “caption.” In this case, since the abnormal region and the expected trace of the wheels do not overlap, it is not always necessary to describe the tags “time” and “gdata” of the tag “Gv.”

As a further embodiment, the generating unit 15e generates deterioration candidate data of which the deterioration level is set to “low” even if discoloration is not detected in the pavement of the road surface on the road image, when an abnormality such as irregularity is detected in the acceleration in the gravitational direction. That is, the generating unit 15e generates deterioration candidate data in which a change in the acceleration in the gravitational direction around the captured time of the road image in which an abnormality such as an irregularity is detected in the road surface pavement, and the coordinate values of the latitude and longitude, including the road image are correlated. In this case, the generating unit 15e also describes the deterioration level as “low” in the tag “mark” of the tag “pointData.” Moreover, the generating unit 15e specifies the azimuth direction along which the vehicle drives from the locus of the coordinate values before the present road image is read and embeds the specified azimuth direction in the tag “caption.”

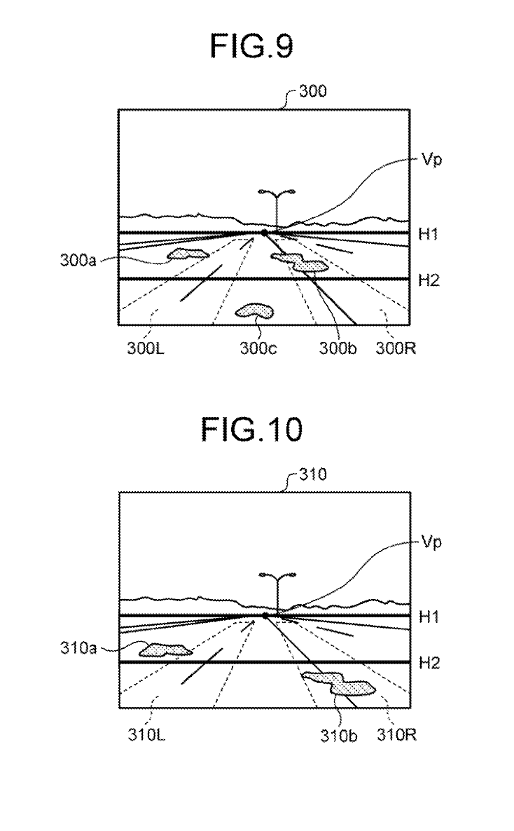

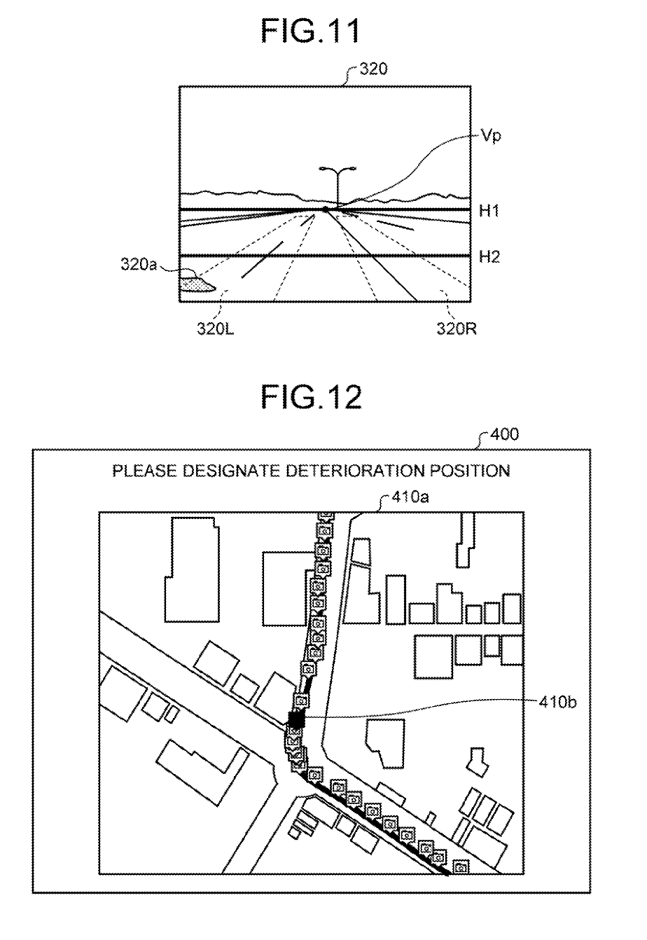

Here, a specific example of a method of generating deterioration candidate data will be described with reference to FIGS. 9 to 11. FIGS. 9 to 11 are diagrams illustrating an example of a road image. In the example of FIGS. 9 to 11, it is assumed that the captured time t1 of a road image 300 is earlier than the captured time t2 of a road image 310 that is earlier than the captured time t3 of a road image 320. An abnormal region 300a illustrated in FIG. 9 is captured as an abnormal region 310a on the road image 310 illustrated in FIG. 10 and is captured as an abnormal region 320a on the road image 320 illustrated in FIG. 11. Moreover, an abnormal region 300b illustrated in FIG. 9 is captured as an abnormal region 310b on the road image 310 illustrated in FIG. 10.

In the case of the road image 300 illustrated in FIG. 9, a region having a height of H2 or smaller that is half the height H1 of the vanishing point Vp is specified by the abnormal region detecting unit 15b as the image processing execution target region E. Since only an abnormal region 300c among abnormal regions 300a to 300c is included in the image processing execution target region E, only the abnormal region 300c is detected by the abnormal region detecting unit 15b. The abnormal region 300c does not overlap traces 300L and 300R along which the left and right wheels of the patrol car 3 are expected to pass. As above, although it is possible to detect the abnormal region 300c, it is not possible to determine whether the abnormal region 300c results from an irregularity such as a bump, a groove, or a crack, or from a discoloration caused by a water pool having a small irregularity. Thus, since the abnormal region 300c is worth inspecting on the next patrol, deterioration candidate data of which the deterioration level is set to “low” is generated from the road image 300.

In the case of the road image 310 illustrated in FIG. 10, a region having a height of H2 or smaller that is half the height H1 of the vanishing point Vp is also specified by the abnormal region detecting unit 15b as the image processing execution target region E. Since only the abnormal region 310b among abnormal regions 310a and 310b is included in the image processing execution target region E, only the abnormal region 310b is detected by the abnormal region detecting unit 15b. The abnormal region 310b overlaps a trace 310R of traces 310L and 310R along which the left and right wheels of the patrol car 3 are expected to pass. In this case, if the acceleration at the measurement time corresponding to the captured time of the road image is outside the predetermined range R, it can be determined that the abnormal region 310b results from an irregularity such as a bump, a groove, or a crack. Thus, since the abnormal region 310b is worth checking the necessity of maintenance, deterioration candidate data of which the deterioration level is “high” is generated from the road image 310.

In the case of the road image 320 illustrated in FIG. 11, a region having a height of H2 or smaller that is half the height H1 of the vanishing point Vp is also specified by the abnormal region detecting unit 15b as the image processing execution target region E. Since only the abnormal region 320a is included in the image processing execution target region E, only the abnormal region 320a is detected by the abnormal region detecting unit 15b. The abnormal region 320a overlaps trace 320L of traces 320L and 320R along which the left and right wheels of the patrol car 3 are expected to pass. In this case, if the acceleration at the measurement time corresponding to the captured time of the road image is within the predetermined range R, it can be said that it is worth checking with the naked eyes whether the abnormal region 320a results from an irregularity such as a bump, a groove, or a crack. Thus, deterioration candidate data of which the deterioration level is “low” is generated from the road image 320.

Returning to FIG. 3, the acquiring unit 15f is a processing unit that acquires the deterioration candidate data 13d stored in the storage unit 13. As an embodiment, the acquiring unit 15f sequentially acquires the deterioration candidate data 13d corresponding to a route name among the deterioration candidate data 13d stored in the storage unit 13 upon receiving a designation of a route name from the subscriber terminal 70. For example, when a route A is designated as the route name, the acquiring unit 15f reads the deterioration candidate data 13d in which the route A is embedded in the tag “caption.”

As another embodiment, when new deterioration candidate data 13d is registered, the acquiring unit 15f may read the new deterioration candidate data 13d. Moreover, the acquiring unit 15f may read the deterioration candidate data 13d that has been newly added in the previous time when a scheduled time has come. In the following description, a case where a designation of the route name is received from the subscriber terminal 70 will be described.

The frequency calculating unit 15g is a processing unit that calculates the frequency at which an acceleration that is outside an allowable range is measured at the deterioration candidate position using the digitacho data 13f.

As an embodiment, the frequency calculating unit 15g reads the digitacho data 13f corresponding to the route name designated by the subscriber terminal 70 from the storage unit 13. Moreover, the frequency calculating unit 15g excludes the digitacho data 13f having an azimuth direction different from the azimuth direction embedded in the tag “caption” of the deterioration candidate data 13d acquired by the acquiring unit 15f from the digitacho data 13f read from the storage unit 13. That is, the frequency calculating unit 15g extracts only the digitacho data 13f of the business vehicle 5 driving in the same direction as the moving direction of the patrol car 3 when the deterioration candidate data 13d is acquired. In this way, a case where the business vehicle 5 makes an abrupt deceleration or a hard turn on a different road surface such as a case where the business vehicle 5 drives on a lane opposite to the driving lane of the patrol car 3 is suppressed from being counted in the occurrence frequency.

The frequency calculating unit 15g selects one digitacho data 13f that is subjected to processing among the digitacho data 13f of the business vehicle 5 that drives in the same azimuth direction as the patrol car 3. Subsequently, the frequency calculating unit 15g determines whether the measurement position of the digitacho data 13f selected earlier corresponds to the deterioration candidate position. For example, the frequency calculating unit 15g determines whether the coordinate values of the longitude and latitude of the digitacho data 13f are within a predetermined allowable distance (for example, a distance such that it can be determined that the business vehicle and the patrol car are driving on the same lane) from the coordinate values of the latitude and longitude of the deterioration candidate position.

In this case, when the measurement position of the digitacho data 13f corresponds to the deterioration candidate position, the frequency calculating unit 15g applies a weight according to the type of the business vehicle 5 in which the digitacho data 13f is acquired. For example, the frequency calculating unit 15g retrieves the vehicle class of the business vehicle data 13e having the same registration number as the registration number included in the digitacho data 13f among the business vehicle data 13e stored in the storage unit 13. After that, the frequency calculating unit 15g applies a reference weight of “1” when the vehicle class of the business vehicle 5 is “ordinary,” applies a weight of “0.5” when the vehicle class is “compact,” applies a weight of “2” when the vehicle class is “mid-size,” and applies a weight of “3” when the vehicle class is “large.” The reason why a larger weight is applied to a heavier vehicle is because the weight of a vehicle is highly likely to be the cause of the road surface deterioration, and it is possible to reflect the degree of influence on the road surface in the occurrence frequency of an abrupt deceleration or a hard turn.

When the measured value of the digitacho data 13f is a deceleration, the frequency calculating unit 15g further adds a weight applied earlier to the abrupt deceleration occurrence frequency to which the previous weight of the abrupt deceleration has been added. On the other hand, when the measured value of the digitacho data 13f is a horizontal G, the frequency calculating unit 15g further adds a weight applied earlier to the hard turn occurrence frequency to which the previous weight of the hard turn has been added.

As above, the frequency calculating unit 15g repeats the processing until a weight is added to the abrupt deceleration occurrence frequency or the hard turn occurrence frequency with respect to all items of the digitacho data 13f. After that, the frequency calculating unit 15g repeats the processing until the abrupt deceleration occurrence frequency or the hard turn occurrence frequency is calculated for all items of the deterioration candidate data 13d corresponding to the route name acquired by the acquiring unit 15f.

The deterioration determining unit 15h is a processing unit that determines whether the frequency calculated by the frequency calculating unit 15g is equal to or greater than a predetermined threshold value. As an embodiment, the deterioration determining unit 15h determines whether the deterioration candidate data 13d will be extracted as the deterioration data 13g based on whether the abrupt deceleration occurrence frequency or the hard turn occurrence frequency is equal to or greater than the predetermined threshold value.

In this case, when the abrupt deceleration occurrence frequency or the hard turn occurrence frequency is equal to or greater than the threshold value, it can be estimated that a discoloration or an irregularity is detected on the road surface, and there is a possibility that the load of vehicle traffic load decreases the service life of the road surface. In this case, the deterioration determining unit 15h registers the deterioration candidate data 13d in the storage unit 13 as the deterioration data 13g. On the other hand, when the abrupt deceleration occurrence frequency or the hard turn occurrence frequency is smaller than the threshold value, it can be estimated that although a discoloration or an irregularity is detected on the road surface, the load of vehicle traffic load is not so heavy to decrease the service life of the road surface. In this case, the deterioration determining unit 15h does not register the deterioration candidate data 13d in the storage unit 13 as the deterioration data 13g. When the deterioration candidate data 13d is registered as the deterioration data 13g, the abrupt deceleration occurrence frequency or the hard turn occurrence frequency can be embedded using a predetermined tag.

The service providing unit 15j is a processing unit that provides the deterioration data 13g to the subscriber terminal 70. As an embodiment, upon receiving a designation of the route name from the subscriber terminal 70, the service providing unit 15j generates a map screen in which the coordinate positions of the position data included in the sensing data 13b are mapped onto the map data corresponding to the route name. In this case, the service providing unit 15j maps a coordinate value of the deterioration position included in the deterioration data 13g among the coordinate positions of the position data included in the sensing data 13b in a display form different from that of the other coordinate values. Moreover, the service providing unit 15j transmits a map screen, in which the deterioration positions are mapped in a different display form, to the subscriber terminal 70. After that, upon receiving a designation of the deterioration position on the map screen from the subscriber terminal 70, the service providing unit 15j reads the deterioration data 13g corresponding to the deterioration position and the video data 13a of the designated route including the road image of the deterioration position from the storage unit 13. Moreover, the service providing unit 15j displays a deterioration position browsing screen generated from the deterioration data 13g and the video data 13a read from the storage unit 13 on the subscriber terminal 70.

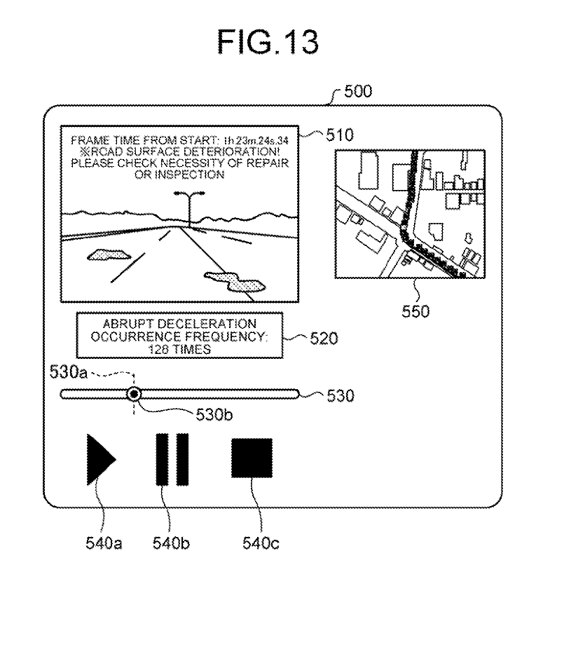

FIG. 12 is a diagram illustrating an example of a screen transmitted to the subscriber terminal 70. As illustrated in FIG. 12, a map screen 400 on which the coordinate positions of the position data included in the sensing data 13b are mapped is displayed on the subscriber terminal 70. In the map screen 400, since a coordinate position 410b of the deterioration position included in the deterioration data 13g is displayed on a map image 410a as a black mark, the road inspector can identify the coordinate position 410b of the deterioration position. When the coordinate position 410b of the deterioration position on the map screen 400 is input via a mouse clicking or pressing of a combination of a Tab key and an Enter key, a deterioration position browsing screen 500 illustrated in FIG. 13 is displayed.

FIG. 13 is a diagram illustrating an example of a screen transmitted to the subscriber terminal 70. As illustrated in FIG. 13, the deterioration position browsing screen 500 including a road image 510 of a deterioration position, an abrupt deceleration occurrence frequency 520, and a map screen 550 is displayed on the subscriber terminal 70. In the deterioration position browsing screen 500, although the road image 510 of the deterioration position is displayed as a still image, it is possible to reproduce the images around the road image 510 of the deterioration position by sliding a slider 530b from a slider position 530a, at which the road image of the deterioration position is displayed, on a seek bar 530. Further, when a play button 540a is operated on the deterioration position browsing screen 500, it is possible to reproduce a movie of an optional zone corresponding to three minutes (±90 seconds) around the captured time of the road image of the deterioration position with the position of the slider 530b as a playback start position. It is possible to pause the move when a pause button 540b is operated during the reproduction of the movie and to stop the reproduction of the movie when a stop button 540c is operated. By displaying the deterioration position browsing screen 500, the road inspector can understand visually, numerically, and geographically the road surface that is highly likely to be worth a repair and the road surface that is highly likely to be worth inspecting on the next patrol.

Processing flow

Next, the flow of the processing of the road surface inspection system 1 according to this embodiment will be described. The processing executed by the road surface inspection system 1 will be described in the order of: (1) a deterioration candidate position detecting process and (2) a deterioration position detecting process that are executed by the road surface inspection device 10, and (3) a service providing process that is executed by the road surface inspection device 10 and the subscriber terminal 70.

(1) Deterioration Candidate Position Detecting Process

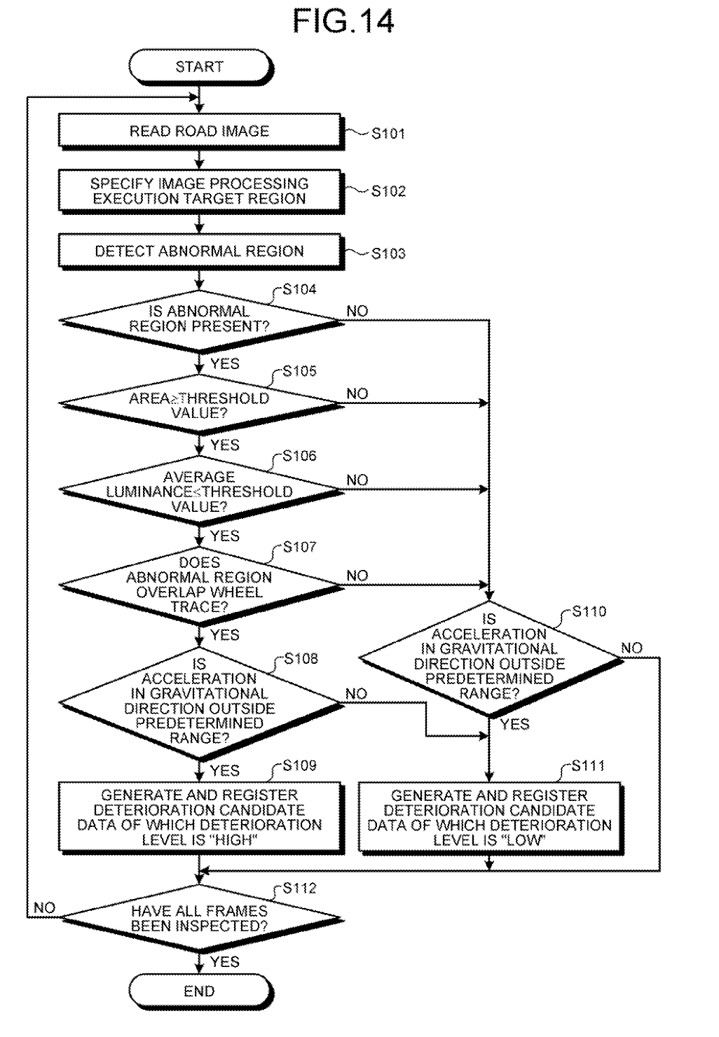

FIG. 14 is a flowchart illustrating the flow of a deterioration candidate position detecting process according to the first embodiment. The deterioration candidate position detecting process is started when new video data 13a is registered in the storage unit 13.

As illustrated in FIG. 14, the abnormal region detecting unit 15b sequentially reads the frames of a road image included in the video data 13a stored in the storage unit 13 (step S101). Moreover, the abnormal region detecting unit 15b specifies the image processing execution target region E based on the vanishing point on the road image (step S102). After that, the abnormal region detecting unit 15b detects an abnormal region, in which it can be estimated that a discoloration or the like is present on the pavement of the road surface, from the specified image processing execution target region E (step S103).

When the abnormal region is present (Yes in step S104), the overlap determining unit 15c calculates the number of pixels that constitute the abnormal region, that is, the area of the abnormal region, and then determines whether the area of the abnormal region is equal to or greater than a predetermined threshold value Δb (step S105).

In this case, when the abnormal region is not present (No in step S104), or when the area of the abnormal region is smaller than the predetermined threshold value Δb (No in step S105), the flow proceeds to step S110.

On the other hand, when the area of the abnormal region is equal to or greater than the predetermined threshold value Δb (Yes in step S105), the overlap determining unit 15c further determines whether an average value of the luminance of the pixels that constitute the abnormal region is equal to or smaller than a predetermined threshold value Δc (step S106).

When the average value of the luminance of the pixels that constitute the abnormal region is smaller than the predetermined threshold value Δc (Yes in step S106), the overlap determining unit 15c executes the following processes. That is, the overlap determining unit 15c further determines whether the abnormal region overlaps a trace along which the wheels of the patrol car 3 are expected to pass, defined by the wheel trace data 13c (step S107). When the average value of the luminance of the pixels that constitute the abnormal region exceeds the predetermined threshold value Δc (No in step S106), the flow proceeds to step S110.

Subsequently, when the abnormal region overlaps the expected trace of the wheels (Yes in step S107), the acceleration determining unit 15d executes the following processes using the sensing data 13b. That is, the acceleration determining unit 15d determines whether an acceleration at the measurement time corresponding to the captured time of the road image is outside a predetermined range R (step S108).

Here, when the acceleration at the measurement time corresponding to the captured time of the road image is outside the predetermined range R (Yes in step S108), the generating unit 15e executes the following processes. That is, the generating unit 15e generates deterioration candidate data of which the deterioration level is set to “high” and registers the deterioration candidate data in the storage unit 13 (step S109). On the other hand, when the acceleration at the measurement time corresponding to the captured time of the road image is not outside the predetermined range R (No in step S108), the generating unit 15e generates deterioration candidate data of which the deterioration level is set to “low” and registers the deterioration candidate data in the storage unit 13 (step S111).

Moreover, when a determination result of No is obtained in step S104, S105, S106, or S107, the acceleration determining unit 15d executes the following processes using the sensing data 13b. That is, the acceleration determining unit 15d determines whether the acceleration at the measurement time corresponding to the captured time of the road image is outside the predetermined range R (step S110).

In this case, when the acceleration at the measurement time corresponding to the captured time of the road image is outside the predetermined range R (Yes in step S110), the generating unit 15e executes the following processes. That is, the generating unit 15e generates deterioration candidate data of which the deterioration level is set to “low” and registers the deterioration candidate data in the storage unit 13 (step S111). On the other hand, when the acceleration at the measurement time corresponding to the captured time of the road image is outside the predetermined range R (No in step S110), the flow proceeds to step S112 without generating the deterioration candidate data.

After that, the road surface inspection device 10 executes the processes of steps S101 to S111 repeatedly until inspection of the road surface ends for all frames (No in step S112). Moreover, when the inspection of the road surface ends for all frames (Yes in step S112), the process ends.

(2) Deterioration Position Detecting Process

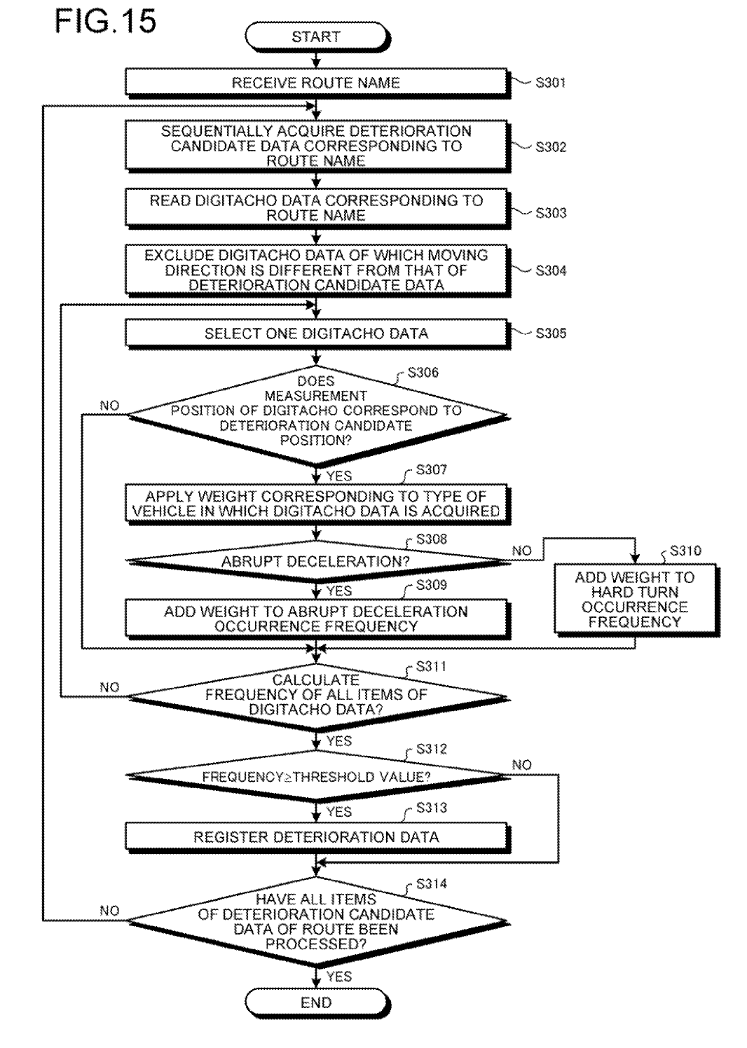

FIG. 15 is a flowchart illustrating the flow of a deterioration position detecting process according to the first embodiment. The deterioration position detecting process is started when a designation of the route name is received from the subscriber terminal 70.

As illustrated in FIG. 15, upon receiving a designation of the route name from the subscriber terminal (step S301), the acquiring unit 15f sequentially acquires the deterioration candidate data 13d corresponding to the route name among the deterioration candidate data 13d stored in the storage unit 13 (step S302).

Subsequently, the frequency calculating unit 15g reads the digitacho data 13f corresponding to the route name designated by the subscriber terminal 70 from the storage unit 13 (step S303). Moreover, the frequency calculating unit 15g excludes the digitacho data 13f having an azimuth direction different from the azimuth direction embedded in the tag “caption” of the deterioration candidate data 13d acquired by the acquiring unit 15f from the digitacho data 13f read from the storage unit 13 (step S304).

After that, the frequency calculating unit 15g selects one digitacho data 13f that is subjected to processing among the digitacho data 13f of the business vehicle 5 that drives in the same azimuth direction as that of the patrol car 3 (step S305). Subsequently, the frequency calculating unit 15g determines whether the measurement position of the digitacho data 13f selected earlier corresponds to the deterioration candidate position (step S306).

In this case, when the measurement position of the digitacho data 13f corresponds to the deterioration candidate position (Yes in step S306), the frequency calculating unit 15g applies a weight according to the type of the business vehicle 5 in which the digitacho data 13f is acquired (step S307). When the measurement position of the digitacho data 13f does not correspond to the deterioration candidate position (No in step S306), the flow proceeds to step S311.

When the measured value of the digitacho data 13f is a deceleration (Yes in step S308), the frequency calculating unit 15g further adds a weight applied earlier to the abrupt deceleration occurrence frequency to which the previous weight of the abrupt deceleration has been added (step S309). On the other hand, when the measured value of the digitacho data 13f is a horizontal G (No in step S308), the frequency calculating unit 15g further adds a weight applied earlier to the hard turn occurrence frequency to which the previous weight of the hard turn has been added (step S310).

After that, the processes of steps S305 to S310 are repeatedly executed until a weight is added to the abrupt deceleration occurrence frequency or the hard turn occurrence frequency with respect to all items of the digitacho data 13f (No in step S311).

When the weight is added to the abrupt deceleration occurrence frequency or the hard turn occurrence frequency with respect to all items of the digitacho data 13f (Yes in step S311), the deterioration determining unit 15h executes the following processes. That is, the deterioration determining unit 15h determines whether the abrupt deceleration occurrence frequency or the hard turn occurrence frequency is equal to or greater than a predetermined threshold value (step S312).

Here, when the abrupt deceleration occurrence frequency or the hard turn occurrence frequency is equal to or greater than the threshold value (Yes in step S312), it can be estimated that a discoloration or an irregularity is detected on the road surface, and there is a possibility that the load of vehicle traffic load decreases the service life of the road surface. In this case, the deterioration determining unit 15h registers the deterioration candidate data 13d in the storage unit 13 as the deterioration data 13g (step S313).

On the other hand, when the abrupt deceleration occurrence frequency or the hard turn occurrence frequency is smaller than the threshold value (No in step S312), it can be estimated that although a discoloration or an irregularity is detected on the road surface, the load of vehicle traffic load is not so heavy to decrease the service life of the road surface. In this case, the deterioration candidate data 13d is not registered in the storage unit 13 as the deterioration data 13g, but the flow proceeds to step S314.

After that, the processes of steps S302 to S313 are repeatedly executed until the abrupt deceleration occurrence frequency or the hard turn occurrence frequency is calculated for all items of the deterioration candidate data 13d corresponding to the route name (No in step S314). When the abrupt deceleration occurrence frequency or the hard turn occurrence frequency is calculated for all items of the deterioration candidate data 13d corresponding to the route name (Yes in step S314), the process ends.

Although the flowchart of FIG. 15 illustrates a case where one item of each of the deterioration candidate data 13d and the digitacho data 13f corresponding to the route name designated by the subscriber terminal 70 is sequentially processed, the respective items of the deterioration candidate data 13d may be processed in parallel.

(3) Service Providing Process

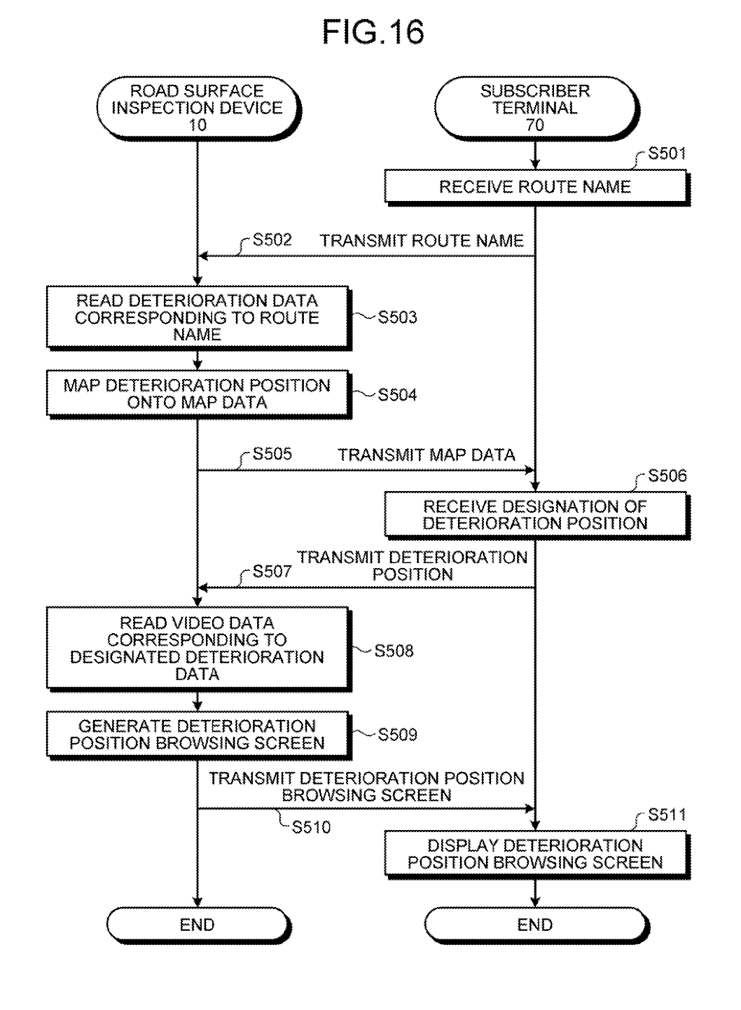

FIG. 16 is a sequence diagram illustrating a service providing process between the road surface inspection device 10 and the subscriber terminal 70 according to the first embodiment. The service providing process is started when a browse request including a designation of the route name is received from the subscriber terminal 70.

As illustrated in FIG. 16, the subscriber terminal 70 receives a designation of the route name (step S501) and transmits the route name to the road surface inspection device 10 (step S502). The service providing unit 15j having received the designation of the route name reads the sensing data 13b and the deterioration data 13g stored in the storage unit 13 (step S503).

Moreover, the service providing unit 15j maps the coordinate position of the position data included in the sensing data 13b and the coordinate value of the deterioration position included in the deterioration data 13g onto the map data corresponding to the route name in different display forms (step S504). Subsequently, the service providing unit 15j transmits a map screen, in which deterioration positions are mapped in different display forms, to the subscriber terminal 70 (step S505).

The subscriber terminal 70 having received the map screen receives the designation of the deterioration position on the map screen (step S506) and transmits the deterioration position to the road surface inspection device 10 (step S507).

In response to this, the service providing unit 15j reads the deterioration data 13g corresponding to the deterioration position designated by the subscriber terminal 70 and the video data 13a of the designated route including the road image of the deterioration position from the storage unit 13 (step S508).

Moreover, the service providing unit 15j generates a deterioration position browsing screen from the deterioration data 13g and the video data 13a read from the storage unit 13 (step S509). After that, the service providing unit 15j transmits the deterioration position browsing screen to the subscriber terminal 70 (step S510). After that, the subscriber terminal 70 displays the deterioration position browsing screen received from the road surface inspection device 10 on a predetermined display unit (step S511).

### Advantage of First Embodiment

As described above, the road surface inspection device 10 according to this embodiment determines whether a deterioration candidate position is a deterioration position by determining whether the deterioration candidate position detected as the candidate position at which the road surface is deteriorated is a position at which deceleration or turning of a predetermined amount or more occurs frequently. Thus, in the road surface inspection device 10 according to this embodiment, rather than relying on detection of one state which involves determining whether discoloration or irregularity is present on the road surface, it is possible to verify the detection result from various perspectives including the perspective of the cause of road surface deterioration by determining whether the deterioration candidate position is a position at which deceleration or turning of a predetermined amount or more which serves as the cause of the road surface deterioration occurs frequently. Therefore, in the road surface inspection device 10 according to this embodiment, it is possible to detect the deterioration position by narrowing down to a position at which the cause of road surface deterioration occurs frequently. Thus, according to the road surface inspection device 10 according to this embodiment, it is possible to improve the detection accuracy of road surface deterioration.

### [b] Second Embodiment

While an embodiment of the disclosed device has been described, this invention may be embodied in various other forms besides the above-described embodiment. Thus, in the following description, other embodiments included in this invention will be described.

Camera Attachment Position

For example, although the first embodiment illustrates a case where the camera 31 is attached to the front of the patrol car 3, the camera 31 may be attached to a predetermined position (for example, around the rear number plate) of the rear of the patrol car 3.

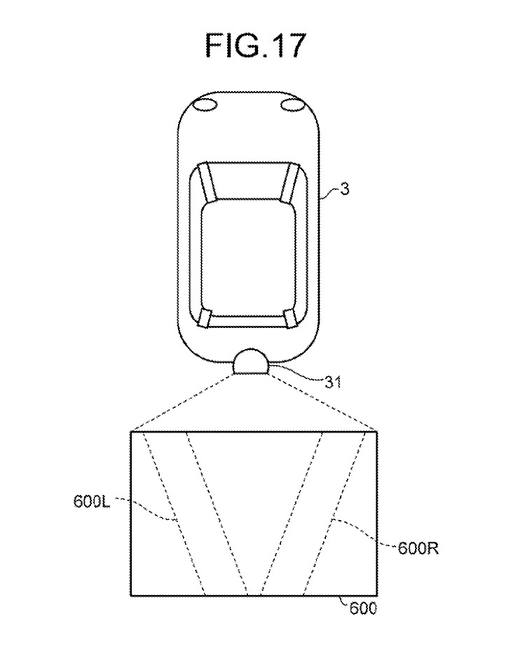

FIG. 17 is a diagram illustrating a modification example of the wheel trace data 13c. In the example of FIG. 17, a case where the camera 31 is attached to the rear of the patrol car 3 is considered. Reference numeral 600 illustrated in FIG. 17 represents a road image. Moreover, reference numerals 600L and 600R illustrated in FIG. 17 represent traces on the road image 600 along which the wheels of the patrol car 3 pass on the road surface. The wheel trace data 13c is set by calibrating the size and the position of a region on the road image, which the left and right wheels pass using the attachment angle of the camera 31 attached to the patrol car 3.

As illustrated in FIG. 17, the two regions of the trace 600L on the road image 600, along which the left wheel of the patrol car 3 passes on the road surface, and the trace 600R on the road image 600, along which the right wheel of the patrol car 3 passes on the road surface are defined as the wheel trace data 13c. As above, when the camera 31 is attached to the rear of the patrol car 3, the disclosed device can perform inspection of the road surface in a similar manner by determining whether the abnormal region overlaps the traces 600L and 600R.

Other Deterioration Candidate Position Detecting Method

Although the first embodiment illustrates a case where a discoloration of the road surface is detected from the road image, and an irregularity of the road surface is detected from the acceleration in the gravitational direction, the application of the disclosed device is not limited to this. For example, the disclosed device may include an acoustic sensor that is mounted on the patrol car 3 so as to capture a driving sound on the road surface and may detect the deterioration candidate position by executing matching between the driving sound captured from the acoustic sensor and a predetermined pattern sound (for example, a sound generated when a vehicle passes through a bump, a groove, or a crack). By detecting the deterioration candidate position using the driving sound, it is possible to effectively detect a small crack on the road surface. Moreover, the disclosed device may acquire the deterioration candidate position from map data on which positions where a road is easily damaged due to the structure of a road, such as a girder part of a bridge, a steep curve, a steep slope, a left-turn position at an intersection, and a frequent lane changing position.

Braking Operation

Although the first embodiment illustrates a case where the deterioration data 13g is extracted from the deterioration candidate data 13d using the abrupt deceleration occurrence frequency or the hard turn occurrence frequency, the disclosed device is not limited to this. For example, the disclosed device may record position data of a position at which a brake is operated as the digitacho data and may extract the deterioration data 13g from the deterioration candidate data 13d based on whether the deterioration candidate position is a position at which the brake is frequently operated. In this way, similarly to the first embodiment, it is possible to improve the detection accuracy of the road surface deterioration.

Moreover, the respective constituent components of the respective devices do not necessarily have such a physical configuration as illustrated in the drawings. That is, a specific distribution and integration form of the respective devices is not limited to the illustrated form, and all or part of the constituent components may be distributed and integrated functionally or physically in optional units according to various types of loads, a use state, or the like. For example, the registration unit 15a, the abnormal region detecting unit 15b, the overlap determining unit 15c, the acceleration determining unit 15d, the generating unit 15e, the acquiring unit 15f, the frequency calculating unit 15g, the deterioration determining unit 15h, or the service providing unit 15j may be connected via a network as an external device of the road surface inspection device 10. Moreover, the registration unit 15a, the abnormal region detecting unit 15b, the overlap determining unit 15c, the acceleration determining unit 15d, the generating unit 15e, the acquiring unit 15f, the frequency calculating unit 15g, the deterioration determining unit 15h, or the service providing unit 15j may be included in different devices, and the respective units may be connected via a network so as to realize the functions of the road surface inspection device 10 in cooperation.

Road Surface Inspection Program

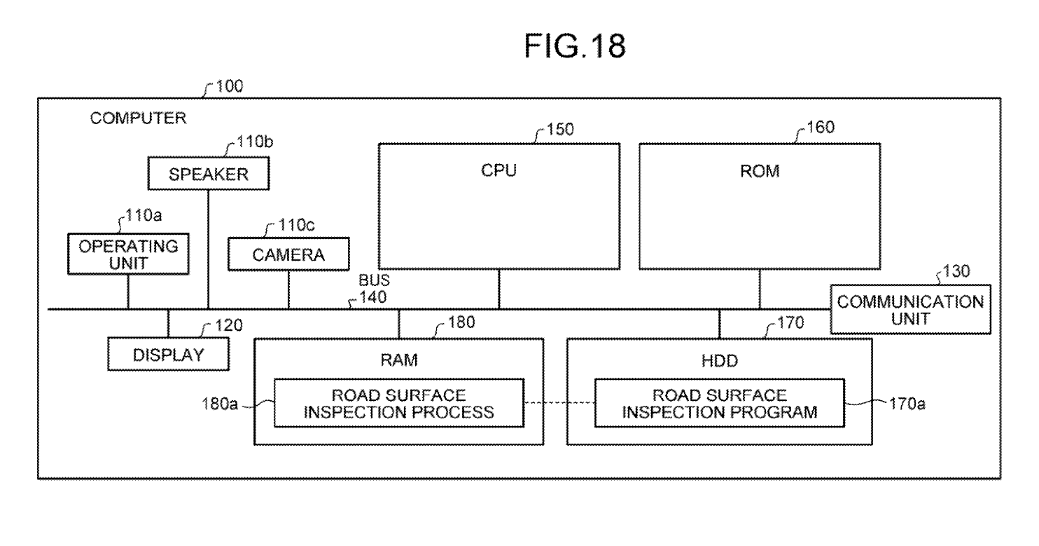

The processes described in the embodiment can be realized by a computer, such as a personal computer or a workstation, executing programs provided in advance. In the following description, an example of a computer that executes a road surface inspection program having the same function as the above embodiment will be described with reference to FIG. 18.

FIG. 18 is a diagram for explaining an example of a computer that executes a road surface inspection program according to the first and second embodiments. As illustrated in FIG. 18, a computer 100 includes an operating unit 110a, a speaker 110b, a camera 110c, a display 120, and a communication unit 130. The computer 100 further includes a CPU 150, a ROM 160, a HDD 170, and a RAM 180. These respective units 110 to 180 are connected via a bus 140.

As illustrated in FIG. 18, a road surface inspection program 170a that performs the same functions as the registration unit 15a, the abnormal region detecting unit 15b, the overlap determining unit 15c, the acceleration determining unit 15d, the generating unit 15e, the acquiring unit 15f, the frequency calculating unit 15g, the deterioration determining unit 15h, and the service providing unit 15j described in the first embodiment is stored in advance in the HDD 170. The road surface inspection program 170a may be appropriately integrated or separated in a manner similarly to the respective constituent components of the registration unit 15a, the abnormal region detecting unit 15b, the overlap determining unit 15c, the acceleration determining unit 15d, the generating unit 15e, the acquiring unit 15f, the frequency calculating unit 15g, the deterioration determining unit 15h, and the service providing unit 15j illustrated in FIG. 3. That is, all of the respective items of the data stored in the HDD 170 may not necessarily be stored in the HDD 170, but only items of the data necessary for the processing may be stored in the HDD 170.

The CPU 150 reads the road surface inspection program 170a from the HDD 170 and deploys the road surface inspection program 170a into the RAM 180. In this way, as illustrated in FIG. 18, the road surface inspection program 170a functions as a road surface inspection process 180a. The road surface inspection process 180a deploys various types of data read from the HDD 170 appropriately into a region allocated to the process 180a, on the RAM 180 and executes various processes based on the deployed data. The road surface inspection process 180a includes the processes (for example, the processes illustrated in FIGS. 14 to 16) executed by the registration unit 15a, the abnormal region detecting unit 15b, the overlap determining unit 15c, the acceleration determining unit 15d, the generating unit 15e, the acquiring unit 15f, the frequency calculating unit 15g, the deterioration determining unit 15h, and the service providing unit 15j illustrated in FIG. 3. Moreover, all of the respective processing units that are realized virtually on the CPU 150 may not necessarily be operated on the CPU 150, but only the processing units necessary for processing may be realized virtually.

The road surface inspection program 170a may not necessarily be stored in the HDD 170 or the ROM 160 in advance. For example, the respective programs may be stored in a “portable physical medium” such as a flexible disk (so-called a FD), a CD-ROM, a DVD disc, a magneto-optical disc, or an IC card, inserted into the computer 100. Moreover, the computer 100 may acquire the respective programs from the portable physical medium and execute the programs. Moreover, the respective programs may be stores in other computers or server devices connected to the computer 100 via a public line, the Internet, a LAN, a WAN, or the like, and the computer 100 may acquire the respective programs from the computers or the server devices and execute the programs.

According to one aspect of a road surface inspection program disclosed herein, it is possible to improve the detection accuracy of the road surface deterioration.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium having stored therein a program that causes a computer to execute a road surface inspection process comprising:
acquiring a deterioration candidate position at which a deterioration candidate of a road surface is detected by a process of detecting an abnormality on the road surface of a road;
calculating a frequency at which an acceleration outside an allowable range is measured at the deterioration candidate position by referring to an acceleration at a measurement position corresponding to the deterioration candidate position among the accelerations stored in a driving data storage in which an acceleration measured in a direction parallel to the road surface on which a vehicle drives by an acceleration sensor mounted on the vehicle and a measurement position at which the acceleration is measured are stored in correlation; and
determining, when the calculated frequency is equal to or greater than a predetermined threshold value, that the deterioration candidate position at which the frequency is calculated is a position at which the road surface is deteriorated.

2. The computer-readable recording medium according to claim 1, wherein the calculating includes calculating the frequency by applying a weight to the vehicle in which an acceleration outside the allowable range is measured at the deterioration candidate position so that a larger weight is applied to a vehicle that is classified as a large-size vehicle.

3. The computer-readable recording medium according to claim 1, wherein the acquiring includes executing a process of acquiring a position at which deterioration of the road surface is detected by any one of a first process of detecting an abnormality on the road surface from an image of the road surface on which the vehicle drives captured by an imaging device mounted on the vehicle and a second process of detecting an abnormality on the road surface on which the vehicle drives from an acceleration in a gravitational direction, measured during driving of the vehicle by an acceleration sensor mounted on the vehicle.

4. A computer-readable recording medium having stored therein a program that causes a computer to execute a road surface inspection process comprising:
acquiring a deterioration candidate position at which a deterioration candidate of a road surface is detected by a process of detecting an abnormality on the road surface of a road;
calculating a frequency at which a braking operation is performed at the deterioration candidate position by referring to an operation position corresponding to the deterioration candidate position among the operation positions stored in a driving data storage that stores an operation position at which the braking operation is performed on a braking device of a vehicle; and
determining, when the calculated frequency is equal to or greater than a predetermined threshold value, that the deterioration candidate position at which the frequency is calculated is a position at which the road surface is deteriorated.

5. A road surface inspection device comprising:
a memory; and
a processor coupled to the memory, wherein the processor executes a process comprising:
acquiring a deterioration candidate position at which a deterioration candidate of the road surface is detected by a process of detecting an abnormality on the road surface of a road;
calculating a frequency at which an acceleration outside an allowable range is measured at the deterioration candidate position by referring to an acceleration at a measurement position corresponding to the deterioration candidate position acquired by the acquiring among the accelerations stored in a driving data storage in which the acceleration measured in a direction parallel to the road surface on which a vehicle drives by an acceleration sensor mounted on the vehicle and the measurement position at which the acceleration is measured are stored in correlation; and
determining, when the frequency calculated by the calculating is equal to or greater than a predetermined threshold value, that the deterioration candidate position at which the frequency is calculated is a position at which the road surface is deteriorated.

6. A road surface inspection device comprising:
a memory; and
a processor coupled to the memory, wherein the processor executes a process comprising:
acquiring a deterioration candidate position at which a deterioration candidate of the road surface is detected by a process of detecting an abnormality on the road surface of a road;
calculating a frequency at which a braking operation is performed at the deterioration candidate position by referring to an operation position corresponding to the deterioration candidate position acquired by the acquiring among the operation positions stored in a driving data storage that stores the operation position at which the braking operation is performed on a braking device of a vehicle; and
determining, when the frequency calculated by the calculating is equal to or greater than a predetermined threshold value, that the deterioration candidate position at which the frequency is calculated is a position at which the road surface is deteriorated.
